(19) United States
(12) Patent Application Publication
(10) Pub. No.: US 2020/0019918 A1
(43) Pub. Date: Jan. 16, 2020

(54) System of Determining Container Load Units From Dispatch Load Units

(71) Applicant: FastFloow Consulting Limited, Kowloon (CN)

(72) Inventor: Frankey Lai Kong Li, Kowloon (CN)

(21) Appl. No.: 16/036,445

(22) Filed: Jul. 16, 2018

(51) Int. Cl. G06Q 10/08

(52) U.S. Cl. CPC G06Q 10/087; B65G 65/30; G06Q 10/0832

(57) ABSTRACT

A system of determining container load units from dispatch load units which allows for packing a container load unit by a homogeneous (identical) type of dispatch load unit and/or by heterogeneous (different types) of dispatch load units. The system allows for the incorporation of practical operational factors, packing preferences and also allows for various empirical overrides. The quantity of container load units and the packing arrangements for each container load unit are generated for various lots of items.

### BACKGROUND OF INVENTION

In commerce, customers place orders with a vendor by specifying different items, each with a quantity. For the logistics, the vendor typically dispatches cargo by units of cartons. Shipment can be either by forwarder or by containers. Forwarder freight will be one lot of all the different cartons, while container freight will be containers of cartons. The logistics is operated on the conversion of units of items to cartons to containers; or more generically referred to items are converted to dispatch load units (DLUs) for dispatch and for container freight, there is a further conversion to container load units (CLUs).

In this conversion of units, the business requirements for forwarding freight are rather straightforward. It is simply different items to their dispatch load units, and all will be freighted in one large lot. However, the business requirements for container freight are more complex; particularly items may not be ordered in unit of containers. The recurring problems for processing containers with different carton sizes, packing constraints and quantities are:
1. How many containers would be required in the sales order.
2. How should the items (or cartons) and quantity be adjusted to achieve units of fully packed and highly utilized containers.
3. The wish to model different container sizes with different items and quantity, and to determine containers required and to see container utilization level.
4. Whatever container quantity and container packing arrangement is finalized at sales should not result in undesirable surprises at dispatch that would create extra costs, delays or freighting issues, yet the containers must be packed suitable for unloading.

The aspiration of businesses is to have a way to algorithmically determine the quantity of container load units based on industry packing/unpacking preferences of different vendor dispatch load units. The ability to determine quantity of container load units will not only be for packing homogenous vendor dispatch load units, but also for packing heterogeneous vendor dispatch load units of different physical and packing properties.

### SUMMARY OF INVENTION

The invention is an algorithm system that will serve both allocating a container load unit by homogeneous (single type of) dispatch load units, and by heterogeneous (different types of) dispatch load units. Since there can be infinite ways to pack a container load unit, the algorithm is based on a balance of a set of practical operational factors, preferences and overhead cost considerations at both ends of the packing and unpacking operation.

The algorithm component for allocating homogeneous dispatch load units to a container load unit will determine the optimal packing arrangement for the maximum quantity of dispatch load units to the container load unit. The algorithm is based on the physical and loading properties of the dispatch load unit and a set of practical operational factors and preferences. The unit conversion of dispatch load unit and container load unit may be manually adjusted to support preferred empirical quantity. This conversion value typically does not change once put into operation and subsequently proven. The conversion value then becomes a look up value.

The algorithm component for packing heterogeneous item associated dispatch load units to container load units will be based on the algorithm component of the homogeneous packing of dispatch load unit to container load unit, and the packing/unpacking preferences at both ends of the operations. This algorithm component is the modeling component executed dynamically based on scenarios on hand.

The algorithm system can be supported by a user interface to facilitate user interaction on scenarios and view outcomes on container load unit quantity and packing details per container load unit. An outline of the operations, features and options provided by the algorithm system is set forth below.
A. An algorithmic system of maintaining unit conversion from item (product) to dispatch load unit (DLU) to container load unit (CLU) comprising:
   1. A database of container load units of cubical geometry with defined profile comprising of interior dimensional properties of length, width and height; door aperture of width and height; and maximum load.
   2. A database of dispatch load units of cubical geometry with defined profile comprising of exterior dimensional properties of length, width and height; weight properties; and loading properties of placement direction, maximum stacks.
   3. Each dispatch load unit of #2 is associated with a conversion rate to each container load units #1 in the database. This conversion rate is automatically derived by an algorithm and it is the Allocable Quantity (Q) of the dispatch load unit to the container load unit. This conversion rate is the maximum number of the dispatch load units maybe allocated into the container load unit. The algorithm determines the conversion rate based on the profile of the dispatch load unit and the container load unit, the usable space within the container load unit, and a set of packing preferences governing possible packing options, which the highest quantity result is picked. The algorithm logic determines allocable quantity of dispatch load units in a spatial unit, which begins as the container load unit's usable space. As the spatial unit is fully allocated by upright dispatch load units, the unallocated spaces around the body of allocated upright dispatch load units are identified as remaining (smaller) cubical spatial units, which are at the overhead and adjacent spaces of the allocated dispatch load units. The same algorithm logic is applied to each of these remaining spatial units (overhead and adjacent) but dispatch load units are place in non-upright orientation. The allocable quantity from each of these spatial units are summed to give the overall Allocable Quantity (Q) by geometry.
   4. Based on #3, all of the automatically derived Allocable Quantity (Q), or conversion rate, between dispatch load unit (DLU) and container load unit may be overridden by an empirical value, which must be a lower value.
   5. An item (or product) may adopt or associate any, and multiple, dispatch load units (DLU) available in the database #2. Each association of item and dispatch load unit results in an item-associated dispatch load unit (IDLU). This item-associated dispatch load unit (IDLU) inherits all the properties of the dispatch load unit (and implying the dispatch load unit (DLU) to all its container load unit conversion rate properties) and it is augmented with a conversion rate of the number of items to the associated dispatch load unit (item-per-IDLU), and a dispatch load unit gross weight.
   6. Based on #5, item-associated dispatch load (IDLU) unit to container load unit conversion rate (Q) at #4 may be automatically lowered due to the container load unit maximum load constraint and the item-associated dispatch load unit (IDLU) gross weight, so the total item-associated dispatch load units (IDLU) gross weight allocated into the container load unit will not exceed the maximum load. This item-associated dispatch load unit (IDLU) to container load unit conversion rate (Q) may also NOT be modified if chose to IGNORE the container maximum load constraint.
   7. The item-associated dispatch load unit (IDLU) to container load unit conversion rate (Q) at #6 maybe overridden by an empirical value, which must be a lower value.
   8. The conversion rate at #7 is the look-up conversion rate (Q) of an item-associated dispatch load unit (IDLU) to a container load unit to be used in scenarios in operations. Based on this conversion rate, a unit allocable volume (V) for the item-associated dispatch load unit (IDLU) to the container load unit is derived.
   9. The unit allocable volume (V) of #8 and conversion rate (Q) of #7 are look-up values representing the single type (homogeneous) item-associated dispatch load unit to the container load unit to be used in operations. The conversion rate (item-per-IDLU) is also a look-up value between the item-associated dispatch load unit and the item, also to be used in operations.
   10. The container load unit usable space of #3 is the interior length, width and height dimension less corresponding reserved space as empirical value to account for (or to represent) loss space from packing/loading operations.
   11. The loading properties governing dispatch load units may or may not be loaded/packed in non-upright orientations and the maximum stacking allowed in each of upright and non-upright orientations.
   12. The packing preference is a behavioral and operational preference facilitating packing and unpacking of container load units based on best practices.
   13. The algorithm of #3 performs allocation of dispatch load units in different combination of placement orientations with preferences and constrains of orientations. The algorithm will pick the combination of placement orientation with a packing arrangement that gives the highest allocable quantity.
B. For a given list of items, unique items or not, each with a specified item-associated dispatch load unit (IDLU) and quantity, an allocation algorithm system derives the number of container load units required to containerize all the dispatch load units comprising:
   1. For each item, specifying the quantity of item-associated dispatch load units (IDLU) derives the quantity of items, which is based on the conversion rate (item-per-IDLU).
   2. The algorithm allocation preference is least diversity of item-associated dispatch load unit (IDLU) types per container load unit for empirically easy loading and unloading of container load units.
   3. The allocation algorithm system prioritizes on determining number of container load units each is allocated with one type (homogeneous) of item-associated dispatch load units (IDLU). This allocation is based on the item-associated dispatch load unit (IDLU) conversion rate (Q).
   4. For all the remaining item-associated dispatch load units of #3, the algorithm next prioritizes on pooling all identical (homogeneous) item-associated dispatch load units to fill full container load units. This allocation is also based on the item-associated dispatch load unit (IDLU) conversion rate (Q).
   5. For all the remaining item-associated dispatch load units of #4, the algorithm next prioritizes on pooling all item-associated dispatch load units with identical profile properties to fill full container load units. This allocation is also based on the item-associated dispatch load unit (IDLU) conversion rate (Q). Despite item-associated dispatch load units allocated into these container load units are different (heterogeneous), since all have identical profile properties, lookup values are identical, the conversion rate (Q) can be from anyone of the item-associated dispatch load unit pooled as candidate for allocation in container load unit.
   6. For all the remaining item-associated dispatch load units of #5, they are of various sizes with different profile properties (heterogeneous) and quantities, the algorithm next to fill container load units prioritizing on fewest different types of item-associated dispatch load units lots (IDLU). For allocating each container load unit, the allocation is based on the lookup allocable volume (V) of each allocating item-associated dispatch load unit, allocating as many item-associated dispatch load units as possible into a container load unit until allocating the NEXT item-associated dispatch load unit will exceed the container load unit interior volume. If, however, container load unit maximum load is to be respected/complied, then if the container load unit is over loaded, item dispatch load unit (IDLU) will be unallocated one-by-one in reversed allocation order until the container load unit is not overloaded. This allocation of item-associated dispatch load units continues until all are allocated to a container load unit. The last container load unit may not be fully allocated/packed.
   7. The total container load units will be the sum of allocated container load units from #3, #4, #5 and #6.
   8. If the list of items is identified to be of different locations, they are organized into location-based and the algorithm is applied to item-associated dispatch load units (IDLU) per location. Each location will result in its own quantity of container load units.

### Commercial Application of Invention

Although the model can be implemented in a spreadsheet or database system, it is most valuable when implemented on an Enterprise Resource Planning (ERP), Customer Relationship Management (CRM) or similar systems that have product records, sales and transactional process features. Typically, these systems only support interactions based on items and item quantity. Quotations or sales orders or specifications potentially involve multiple item provision sources ranging from own warehouses to different suppliers and their warehouses all can be from different geographical locations, and even be freighted by different freight modes of sea/waterway, road, rail and air. Customers may want to investigate different items, dispatch load units, quantities and container sizes to examine optimal cargo transfer configuration in a quotation for an acceptable logistics cost. This is not exactly easy for the sales team consistently provide good estimations based on dispatch load units and container load units per dispatch location, and their alignment with back office logistics operations. Interaction between customers and sales team, sales team and logistics, and sales team and procurement will need to separately perform unit conversion over and over again and be aligned, which cannot be simple and takes time and is error prone. This algorithm system, in the form of a tool, may potentially help the industry to reduce a lot of waste in the form of costs and time and to improve communication and operational effectiveness.

This algorithm system can be most valuable to merchants of commerce, industry and third party logistics industry who have a high volume of transactions, which are time critical and need operational consistency and accuracy. Furthermore, the use of the model can help companies of these industries to be more immune to skilled staff turnover, reduce training costs, reduce errors and have more continuous process flow. Since the model is not particularly complex and can be a modeling feature put into systems and webpages, it is within the means of the tens of thousands of small and medium size enterprises that exist in the supply chain.

There can be many approaches to the marketing to increase exposure and capture enhancement feedbacks. It could be:
1. Deployed as a demonstration system with scenarios for communication and market interaction. This could be at a website or at a popular ERP and CRM system.
2. The system can be modularized and be an add-on module to a CRM modeling and planning system, and to an ERP modeling and transactional operations system, making the invention available to different audiences with different needs.

### BRIEF DESCRIPTION OF THE DRAWINGS

FIG. 1 is a generalized block diagram for a setup and operate module;

FIG. 2 is a flowchart illustrating the homogeneous allocation algorithm model;

FIG. 3 is a representative chart showing an example scenario with a given list of items in the first column, a selected dispatch load unit (DLU) in the second column, an DLU quantity in the third column, an allocable quantity in the fourth column, a full CLU quantity in the fifth column and a DLU quantity remainder in the sixth column;

FIGS. 4A-4C are respectively a flowchart illustrating the heterogeneous allocation algorithm model;

FIG. 5 is a block diagram illustrating properties and preferences required by the homogeneous allocation model to determine the homogeneous allocation lookup conversion value.

FIG. 6 is a block diagram illustrating the homogeneous allocation sequence in the algorithm;

FIG. 7 is a diagram illustrating allocation arrangements possible of a two blocks system in a spatial unit, where the main block has a facing direction and the other block has a different facing direction and placement location. Further, the spatial unit here is representative of a cubical space in a container load unit and objects are representative of dispatch load units;

FIG. 8 is a diagram illustrating the two blocks system on the possible placement of the other block relative to the main block.

FIG. 9 is a diagram illustrating the possible location and area of the residual adjacent space once a two block system is applied to a spatial unit. It also illustrates the location and area of the residual overhead space from the main block and the other block.

FIG. 10 is a block diagram for calculating allocable quantity for a given spatial and objects dimensions based on the two blocks system with two allocation arrangements, one based on front facing direction (FS) and another on side facing direction (SF).

### DETAILED DESCRIPTION

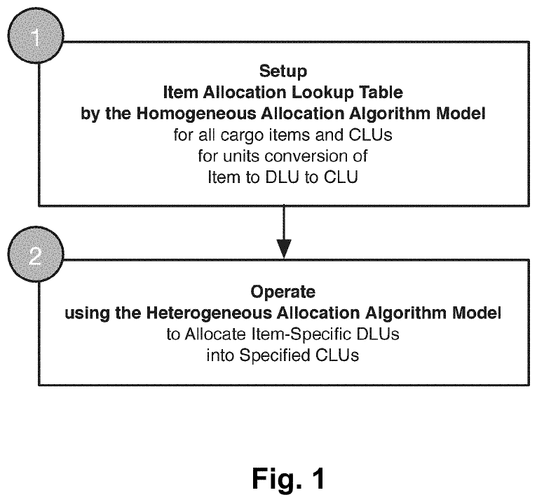

With reference to the drawings, a system of determining container load units from dispatch load units derived from a list of items is illustrated for various embodiments which embrace a wide range of applications depending on the nature of the items, the configurations of possible dispatch load units, such as cartons, pallet-load and the configurations of possible container load units such as intermodal containers, trucks, unit load device, etc. . . . In FIGS. 1, 2, 4A-4C and 6, generalized sequential method steps are designated by numerals in a circular background for explanatory purposes. The system of determining container load units from dispatch load units based on specified items is described in the specification in a generally progressive fashion from illustrating a generally basic application and straightforward system embodiment to more complex applications and more complex system embodiments involving a wide range of considerations, constraints and options.

### Organization of Information

1. Definitions

1. Container Load Unit

2. Dispatch Load Unit

3. Dispatch Load Unit and Container Load Unit Relationship

4. Item or Product

5. Item and Dispatch Load Unit Relationship
2. Operational Factors & Preferences
3. Algorithm for Determining Container Load Unit Quantity

1. The Constraints

2. Packing Preferences

3. Algorithm Strategy

4. Homogeneous Allocation Algorithm Model
1. Allocation by Geometry
   1. Properties of Load Units
   2. Recursive Allocation Method & Two Blocks system
   3. Spatial Unit Representing a Container Load Unit
   4. Allocation of Dispatch Load Unit
   5. Allocation of Upright Objects
   6. Allocation of Non-Upright Objects
2. Allocation by Geometry Calculation Approach
3. An Illustrated Example of Calculating the Allocable Quantity
4. Homogeneous Allocation Algorithm Extension
   1. Empirical Adjustment of Allocable Quantity from Allocation by Geometry
   2. Allocation by Weight
   3. Empirical Adjustment of Allocable Quantity from Allocation by Weight
5. Packing Arrangement Details in a Container Load Unit

5. Heterogeneous Allocation Algorithm Model
1. An Illustrated Example of Calculating the Container Load Unit Quantity
   1. Allocation by Allocable Quantity on Item
   2. Allocation by Allocable Quantity of Identical Allocation Properties
   3. Allocation by Allocable Volume and Weight
   4. Totalling Required Container Load Units
2. A More Complex List of Dispatch Load Units for Calculation
3. Packing Arrangement Details in Container Load Units
4. Variation to the Heterogeneous Allocation Algorithm Model

### Definitions

### Container Load Unit

Any container load unit (CLU or Container) that may containerized cargo, such as intermodal freight containers, trucks or any unit load device is expected to have the following properties:
1. Interior length—from the back of the container to the front/opening/doors
2. Interior width—between the sides of the container
3. Interior height, also representing the upright orientation of the container.
4. Maximum load—the maximum gross weight of content the container can support/hold.
5. Container is of a solid and static cubical shape, which the shape is maintained and not reduced or expanded or deformed in any of the length, width or height dimensions.
6. Container may be moved around but its height orientation is always maintained in the upright orientation; thereby maintaining the contents' original placement orientation and preventing damage.

### Dispatch Load Unit

Any unit cargo that is dispatched by one party as a dispatch unit, fulfilment unit or shipment unit, and received by another party is a dispatch load unit (DLU). It is considered as having a cubical shape occupying space, typically in a carton form, is expected to have the following properties:
1. A well determined top/bottom. Representing the upright orientation. Referencing a carton typically can be identified by the flaps to open/close the carton box. The unit's upright orientation is often essential to be maintained to preserve the integrity of the dispatch load unit and its content.
2. A well determined front/back. The upright faces that typically inform everyone what the content of the dispatch load unit is. Referencing a carton, typically are the faces with the content details and depictions are printed, and it is parallel to the line where the top/bottom closing flaps meet. Also identifies the front facing orientation referenced in packing operations.
3. A well determined sides/ends. The other upright faces adjacent to the front/back and top/bottom faces.
4. Exterior height is the distance between the top and bottom of the dispatch load unit.
5. Exterior length—It is referred to the front or back face of the dispatch load unit. It is the width of this face, or equivalent to the distance between the two sides/ends.
6. Exterior width/depth—It is referred to the side/end face of the dispatch load unit. It is the width of this face, or equivalent to the distance between the front and back face.
7. Gross weight—is the weight of the dispatch load unit with content
8. Placement direction of the dispatch load unit when placed inside a container load unit, with its front/back face may be placed facing the container opening/door, the container side, or either. The placement direction does not change the dispatch load unit's upright orientation.
9. Stacking of dispatch load unit means one dispatch load unit is placed on top of another dispatch load unit, along the height of the container load unit.
10. Maximum stacks allowed for dispatch load unit at its upright orientation—the stacking could be ranged from one (1) and upwards based on the engineering design of the dispatch load unit. This property may be identified with a positive integer number as:
   1. One (1) for allowing dispatch load unit to lie on its upright orientation but no other dispatch load units may stacked on top.
   2. Two (2) for allowing dispatch load unit to be stacked with maximum two layers.
   3. Three (3) for allowing dispatch load unit to be stacked with maximum three layers.
   4. And identical logic for larger integer numbers.
11. Maximum stacks allowed for dispatch load unit placed on its front/back orientation—meaning the dispatch load unit's front/back face becomes the top/bottom with the original width becomes the height. This placement orientation is not preferred; hence it is subordinate to upright placement orientation. This property may be identified with a positive integer number as:
   1. Zero (0) for disallowing dispatch load unit to lie on its front/back face.
   2. One (1) for allowing dispatch load unit to lie on its front/back face but no other dispatch load units may stacked on top.
   3. Two (2) for allowing dispatch load unit to be stacked with maximum two layers all layers lie on its front/back face.
   4. Three (3) for allowing dispatch load unit to be stacked with maximum three layers all layers lie on its front/back face.
   5. And identical logic for larger integer numbers.
12. Maximum stacks allowed for dispatch load unit placed on its side/end orientation—meaning the dispatch load unit's side/end face becomes the top/bottom with the original length becomes the height. This placement orientation is not preferred hence it is subordinate to upright placement orientation. This property may be identified with a positive integer number as:
   1. Zero (0) for disallowing dispatch load unit to lie on its side/end face.
   2. One (1) for allowing dispatch load unit to lie on its side/end face but no other dispatch load units may stack on top.
   3. Two (2) for allowing dispatch load unit to be stacked with maximum two layers all layers lie on its side/end face.
   4. Three (3) for allowing dispatch load unit to be stacked with maximum three layers all layers lie on its side/end face.
   5. And identical logic for larger integer numbers.
13. Dispatch load unit is of a solid and static cubical shape, i.e. the shape is maintained and not reduced or expanded or deformed in any of the length, width or height dimensions.
14. Dispatch load units packing into a container load unit prefer to maintain their upright orientations.
15. Dispatch load units packing into a container load unit much less preferred to be placed in non-upright orientations, such as lie on its front/back or side/end faces. If, however, the non-upright orientation(s) is allowed, dispatch load units will only be placed at spaces not occupied by dispatch load units in the upright orientation.

### Dispatch Load Unit and Container Load Unit Relationship

1. Dispatch load unit is the unit being considered in packing a container load unit. It is the content of the container load unit. It is a cargo unit and it is the container load unit's cargo.
2. A dispatch load unit is small enough to move freely in and out of a container load unit in its upright orientation. A dispatch load unit is also small enough to move freely in and out of a container load unit in its non-upright orientations if it is allowed to be packed in the corresponding non-upright orientation.
3. A container load unit constrains how many dispatch load units can be packed/loaded by its interior dimensions length, width and height.
4. A container load unit also constrains how many dispatch load units can be packed by having a maximum load property. The gross weight of the dispatch load units packed/loaded normally cannot be allowed to exceed the container load unit's maximum load property. However, at times, users may ignore this maximum load constraint. The geometry of the container load unit constrains the maximum quantity of dispatch load units can be packed, but with the maximum load property may further reduce this maximum quantity by geometry.
5. Dispatch load unit at times has preference in placement direction in the container load unit often to facilitate unpacking or to avoid damage.

### Item or Product

1. Item is an object unit being referred to in the business process interactions between customers and vendors.
2. Item also has a quantity unit being referred to in the business process interaction.

### Item and Dispatch Load Unit Relationship

1. Item is the content of a dispatch load unit. The quantity of items to the dispatch load unit is well defined, and may not always be a one to one relationship; it could be a larger integer value. The quantity of items to a dispatch load unit is a conversion ratio between item and dispatch load unit. An instance of a dispatch load unit associated with an item can be referred to as an Item Dispatch load unit (IDLU).
2. With items packed into a dispatch load unit, it is assumed that there will be no alteration to the dispatch load unit except its gross weight will be increased.
3. An item can adopt many different dispatch load units; each item dispatch load unit implies a unit conversion and a set of physical and loading properties.
4. Business interactions refer to items; logistics refer to dispatch load units.

### Operational Factors & Preferences

1. Container load unit maximum load or gross weight may or may not be respected. It is a user option.
2. The packing/loading process of dispatch load units into a container load unit may not be perfect, where dispatch load units may be not placed abut each other, which may be referred to as loosely packed or loose packing. Loose packing may be intentional or unintentional in reality. In terms of determining the allocable quantity of dispatch load units to a container load unit, it may be assumed packing is perfect and make adjustments to account for possible loose packing. This adjustment is in the form of reserved length, width and height, where it is subtracted from the corresponding interior length, width and height of the container load unit to determine the available space for packing.
3. The algorithm is based on packing/unpacking preferences described in this paper and shows a packing arrangement but the actual packing arrangement done by the packing personnel may vary slightly. However, the allocable quantity determined of the dispatch load units in a container load unit is preserved and is consistent between the planning in the algorithm/calculation and the actual packed/loaded cargo or items.

### Algorithm For Determining Container Load Unit Quantity

### The Constraints

The result of a system algorithm must serve all parties:
1. Business interactions specify items and item quantity, while logistics process specify dispatch load units and container load units.
2. Dispatch load unit comes in all sizes and with loading properties, while packing container load units need to comply with packing preferences to account for reality packing constraints.
3. Essential to pack container load unit for ease of packing at dispatch location and unpacking at receiving location.
4. The algorithm not only needs to determine the minimum container load unit quantity required but also to show packing plan on how dispatch load units are allocated in the container load unit for container load unit based review and information.

### Packing Preferences

1. Most preferred—is container load unit is packed with only one single (homogeneous) lot of dispatch load units of one type of item.

1. Rationale:
1. For packing a container: It is most desirable to be filled with just one type of (homogeneous) dispatch load unit, which will have a proven allocable quantity and a standardized packing arrangement of the dispatch load units to a container load unit.
2. For unpacking a container: Easier to process unpacking the container load unit because it is easier to organize and route the unloaded dispatch load units of a single item type to storage.

2. More detailed preference:
1. For each item user specified in a quotation/specification/scenario, the preference is to determine full container load units from the item quantity or the item-associated dispatch load unit quantity. Any dispatch load units of the item remaining unable to fully occupy a container load unit will be for deferred allocation in the algorithm. This demands the algorithm to have a prior determined allocable quantity for the item's dispatch load units to the specified container load unit.
2. For identical items user specified in the quotation in separate lines, if their dispatch load units are identical, they are also most preferred to be packed together.
2. Next preferred—is container load unit is packed full of dispatch load units with identical physical and loading properties and allocable quantity, even though these dispatch load units are of different items.

1. Rationale:
1. For packing a container: Despite the items being different, every aspect of the dispatch load units of those items is identical, so in terms of packing they are treated as a single dispatch load unit type. A container load unit packed full of these dispatch load units will be packed most optimal because the packing arrangement and allocable quantity is proven and standardized so as to have low packing complexity.
2. For unpacking a container: The preference is to have the fewest item types in a container load unit so it can be of lesser effort to organize and route items to their rightful storage locations. The preference is also to keep to fewest container load units with many different items so that fewer container load units need many routing to different storage locations. This preference is also preferred in the packing of a container load unit where the fewer the items are planned for a container load unit, the faster the container load unit can finish packing, be sealed and be released to the freighting party.

2. More detailed preference:
1. The preference would be container load units full of dispatch load units of identical properties. The remainder dispatch load units unable to fully occupy a container load unit will be for deferred allocation in the algorithm.
2. Dispatch load units of an item are organized into a lot. When having different lots and all need to be packed into container load units, they are sorted typically based on their lot volume, to pack into container load units; so those earlier packed container load units will have fewest different items and later container load units have more different items. This also ensures an item would not be too scattered over many container load units making targeted unloading of a specific item less troublesome in operations.
3. Least preferred but inevitable—is container load unit is packed full of dispatch load units of different items, sizes and loading properties.

1. Rationale:
1. For packing a container: Not only are these container load units may not be packed with most optimized utilization of space and packing can be inconsistent based on skills, but also most difficult to have consistency in determining container load unit quantity. This is where the algorithm would provide a consistency in packing arrangement and allocation quantity. However, the primary target in the algorithm is to not underestimate container load units required because the nature of packing operations is time critical and often cannot wait for delivery of further container load units, but needs to be able to achieve very good utilization of container load unit to both reduce logistics cost yet maximize packing density.
2. For unpacking a container: Again, the preference is to have the fewest item types in a container load unit, and fewest container load units with many different item types. It is for the same reasons of ease of operations at both ends of the dispatch and receiving locations.

2. More detailed preference:
1. Unlike packing a container load unit with dispatch load units of uniform size and loading properties, each container load unit allocable quantity must be individually determined and with bespoke packing arrangement. An approach to determining this bespoke allocable quantity is based on the dispatch load unit Allocable Volume (V) to the container load unit, where it has a proven allocable quantity value used in the most preferred packing arrangement (above). It is simply the interior available volume of the container load unit divided by the dispatch load unit Allocable Quantity (Q). It implies the volume the dispatch load unit would occupy by its physical form plus an equal share of the unused space of the container load unit.
2. Similar to the approach above, for all the items not assigned to a container load unit, item dispatch load unit lots are sorted based on their lot volume, to pack into container load units until all item dispatch load units are assigned a container load unit. Again, earlier packed container load units will have fewest different items and later container load units have more different items. The objective is to ensure an item would not be too scattered over many container load units making targeted unloading of a specific item less troublesome in operations. Besides packing these dispatch load units by allocable volume, the packing must comply with container load unit properties and can or cannot exceed its maximum load.
4. Packing a container load unit always starts from the furthest corner and side from the container load unit door opening.

1. Rationale:
1. It is the most intuitive, efficient and common packing approach adopted by warehouse operations.
5. Dispatch load units preferred to be packed and stacked to result in a plane and flat surface for the next stack above, unless there will be no more dispatch load units to be stacked on top.

1. Rationale:
1. Gives the maximum utilization of space
2. Easier packing and unpacking operation with the least damage to content during handling
3. Uneven surface creates pressure points on bottom of dispatch load units due to weight and may lead to damage to its content, so to be avoided.
6. Dispatch load units preferred to be organized into as large a lot as possible with the same placement orientation, such as all are placed upright (or lie on back face or on side face); and all facing in the same direction.

1. Rationale:
1. For efficient loading and unloading of units
2. For the least handling complexity of loading and unloading of units
3. For minimal instructions and communication of packing arrangements along the work flow
7. Intrinsic preferences and properties of dispatch load unit—whether it is by design specification of the dispatch load unit or for the preservation of the content it is holding.
   1. Dispatch load unit always want to be handled and placed in its upright orientation. Only by design or special circumstances would a dispatch load unit be allowed to be packed/placed in its non-upright orientation. Dispatch load units only placed in non-upright orientation in the container load unit when no more in the upright orientation can be loaded.
   2. Dispatch load unit may have a stacking limitation to avoid damage to the structural integrity of the dispatch load unit or to its content.
   3. In relation to a container load unit, the dispatch load unit may require reservation space inside the container load unit for packing and unpacking. These reservation spaces are typically empirically determined. These spaces would account for non-ideal packing factors such as dispatch load units:
      1. May expand in dimension due to over packing or the weight from stacking
      2. Maybe too loosely packed where gaps between dispatch load units are greater than normal
      3. Require extra space for the process of loading/unloading and maneuvering inside the container load unit
   4. Dispatch load unit support stacking lie on back face or lie on side face does not support further stacking on top.
   5. The algorithmically determined allocable quantity, the quantity may support override to support an empirically derived allocable quantity.
8. Intrinsic preferences and properties of container load unit—for the integrity of the container load unit and protection of its content.
   1. Maximum load, which may or may not be complied with by users of the container load unit.

### Algorithm Strategy

The relationship among item, dispatch load unit and container load unit is a unit conversion system of item to dispatch load unit to container load unit.

How many dispatch load units can fit into a container load unit is constrained by geometry. With loading properties, adjustment for loose packing and compliance to packing preferences, the resultant Allocable Quantity (Q) is the maximum quantity of dispatch load units that can be packed into a container load unit. The calculation is by an algorithm on allocating homogeneous dispatch load units into a container load unit. This allocable quantity can be thought of as maximum quantity of empty boxes based on geometry.

When a dispatch load unit is associated with an item (IDLU), as its content, and with the number of items that maybe packed into it, it has an additional weight property as gross weight. Similarly, container load unit has a maximum load limit, which may or may not be respected. If respected, the Allocable Quantity (Q) maybe reduced so the gross weight of all allocable dispatch load units may not exceed the container maximum load. This allocable quantity can be thought of as maximum quantity of cargo boxes. This allocable quantity is also associated with an Allocable Volume (V) to represent the volume required to pack the item-associated dispatch load unit into the container load unit.

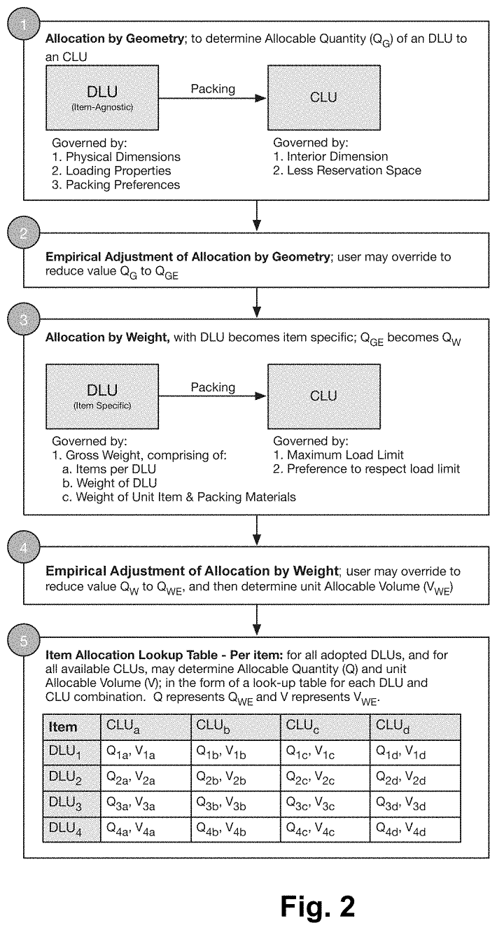

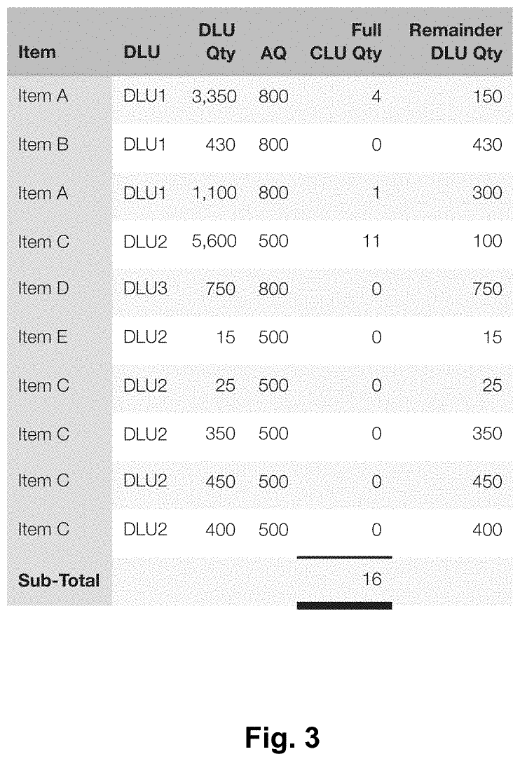

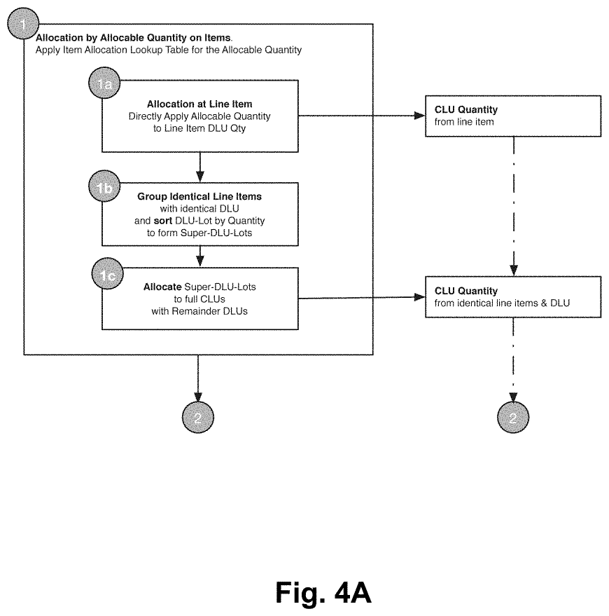

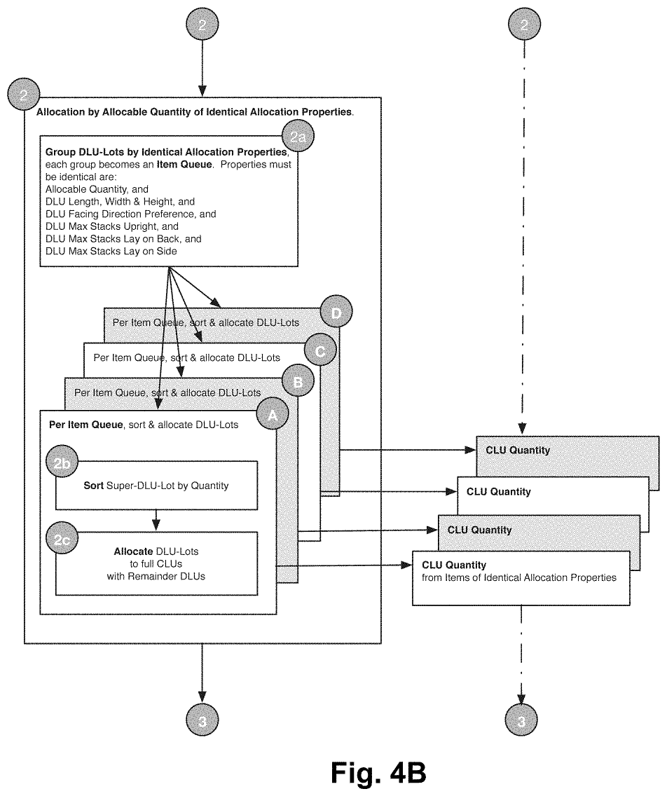

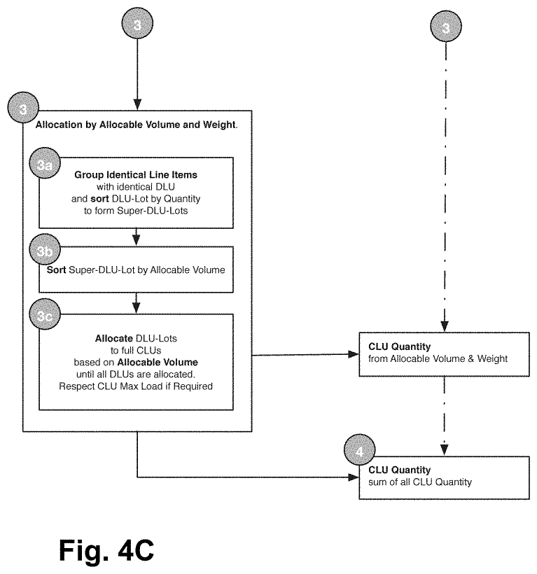

For a given list of item-associated dispatch load units (IDLU) and a supported list of container load unit (CLU), to determine the number of container load units required in the scenario, the algorithm strategy is a Setup and Operate model as set forth in FIG. 1:
1. Every item is set up with an Item Allocation Lookup Table with unit conversion look-up of Allocable Quantity (Q) and Allocable Volume (V) for each of the Item-associated dispatch load units (DLU) and all supported container load unit (CLU). The overview of the homogeneous allocation algorithm, in FIG. 2, shows the derivation of the Item Allocation Lookup Table. The table details how many items to its associated dispatch load unit, and the Allocable Quantity of the dispatch load unit to a container load unit. The Allocable Volume is based on the Allocable Quantity, is the average volume occupied by a dispatch load unit in the container load unit. Both the Allocable Quantity and Allocable Volume are used by the heterogeneous allocation algorithm.
2. For a given list of items, each with a selected dispatch load unit and quantity, and specified to be containerized by a selected container load unit, the number of container load units required can be determined by the heterogeneous allocation algorithm, which makes use of the Item Allocation Lookup Table. Referencing FIG. 3, Full CLU Qty for each line is derived by Allocable Quantity lookup while DLU Qty Remainder shows the remainder DLU quantity not filling a CLU. These remainder DLU quantity from all the lines will continue to apply the heterogeneous allocation algorithm, refer to FIGS. 4A-4C, to determine further CLU quantity to have them all packed or allocated.

### Homogeneous Allocation Algorithm Model

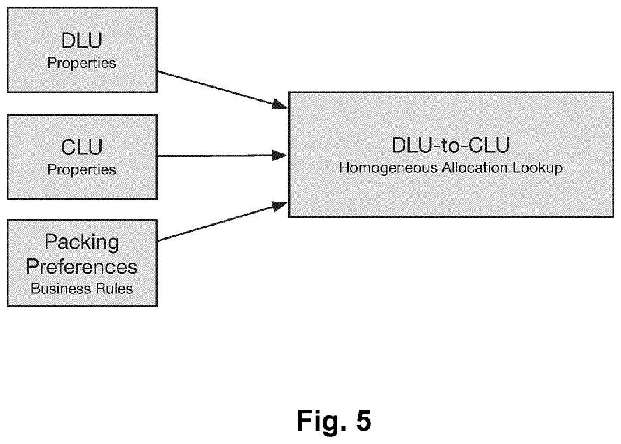

The aim of the homogeneous allocation algorithm model is to determine how many dispatch load units, all being identical (homogeneous), can be allocated into a given container load unit. The allocation will be based on the properties of the dispatch load unit (DLU) and container load unit (CLU) and comply with the packing preferences as indicated at FIG. 5.

The homogeneous allocation algorithm model is depicted in FIG. 2 spanning steps #1-4, and result in a lookup table at step #5. Although the core of the algorithm is at step #1, the entire model includes the extensions to adjust the Allocable Quantity at steps #2-4. The Allocable Volume is derived at step 4 based on the final Allocable Quantity to the container load unit.

The homogeneous allocation algorithm model is a four steps model as explained below, ref. FIG. 2.
1. Allocation by Geometry (Q_{G}). This is the foundation of the model. It is to determine how many of a dispatch load unit (DLU) can fit inside a container load unit for a geometrical maximum allocable quantity. This calculation is elaborated at the sections below. The dispatch load unit here is a cubical object not specific to any item; it can be considered as an empty box.
2. Empirical Adjustment of Allocation by Geometry (Q_{GE}). This geometrical maximum allocable quantity can be adjusted by the user for alignment to some practical or empirical quantity. This user updated empirical geometrical maximum allocable quantity is the final allocable quantity of the non-item-specific dispatch load unit. This overridden allocable quantity at this step cannot be larger than the calculated maximum allocable quantity at step 1.
3. Allocation by Weight (Q_{W}). When the dispatch load unit (DLU) is associated with an item, the dispatch load unit (IDLU) has an additional gross weight property that may impact the allocable quantity since a container load unit (CLU) has a maximum load limit. If the dispatch load unit is to respect this maximum load limit, only the quantity of dispatch load units with the total gross weight less than or equal to the container load unit maximum load can be allocated to the container load unit. This weighted allocable quantity cannot exceed the geometrical maximum allocable quantity, which may be empirically adjusted at step 2.
4. Empirical Adjustment of Allocation by Weight (Q_{WE}). For an item specific dispatch load unit (IDLU), its weighted allocable quantity may also be manually adjusted for alignment to some practical or empirical value. This value cannot be larger than the weighted allocable quantity of the item dispatch load unit at step 3. This updated value is the final Allocable Quantity (Q) for the conversion of the item-specific dispatch load unit to the container load unit. Based on this final allocable quantity and the interior volume of the container load unit, the Allocable Volume (V) can be determined. This allocable volume can also be interpreted as the physical volume of the dispatch load unit plus an average unused space in the container load unit.
5. Item Allocation Lookup Table. For an item adopted many different dispatch load units, and for all the supported container load units in the operating environment of the user, each combination of dispatch load unit and container load unit can have a set of Q and V calculated. For each combination, the Q and V can be determined by simply going through step #1-4 above.

### Allocation by Geometry

The allocation of a dispatch load unit to a container load unit is based on a list of properties and packing preferences, ref. FIG. 5. The algorithm is detailed in the following sections.

### Properties of Load Units

The algorithm for the allocation by geometry is based on two sets of properties; one from the dispatch load unit, another from the container load unit. For convenience of reading, we will refer to dispatch load unit as DLU or Carton (ctn), and container load unit as CLU or Container (ctr).
1. The container load unit (ctr) properties are listed at Table I:

TABLE I

| Property | Type | Description |
|---|---|---|
| L_{ctr} | Decimal | Interior length of container; from door/front to |
| | | back of container |
| W_{ctr} | Decimal | Interior width of container, between the left & right |
| | | sides of container. |
| H_{ctr} | Decimal | Interior height of container & defines the upright |
| | | orientation of the container |
| M_{ctr} | Decimal | Maximum load/mass the container may hold |
| Lᵣₑₛₑᵣᵥₑ | Decimal | Interior length reserved not for packing, so container |
| | | interior length usable for packing is reduced by the |
| | | amount. Value must be less than the container interior |
| | | length. |
| Wᵣₑₛₑᵣᵥₑ | Decimal | Interior width reserved not for packing, so container |
| | | interior width usable for packing is reduced by the |
| | | amount. Value must be less than the container interior |
| | | width. |
| Hᵣₑₛₑᵣᵥₑ | Decimal | Interior height reserved not for packing, so container |
| | | interior height usable for packing is reduced by the |
| | | amount. Value must be less than the container interior |
| | | height. |

2. The dispatch load unit (ctn) has these dimensional and loading properties are listed at Table II:

TABLE II

| Parameter | Type | Description |
|---|---|---|
| L_{ctn} | Decimal | Exterior length of carton front face. |
| W_{ctn} | Decimal | Exterior width of carton side face |
| H_{ctn} | Decimal | Exterior height of carton & defines the upright |
| | | orientation of the carton, with carton top & bottom |
| D_{facing} | List | For cartons packed in upright orientation, the |
| | | preference on facing direction: |
| | | 1. Face Container Opening - Carton packing |
| | | primarily on carton front face at direction of |
| | | container opening |
| | | 2. Face Container Side - Carton packing primarily |
| | | on carton front face at direction of container side |
| | | 3. Higher Of - Carton packing arrangement of the |
| | | two choices (1 & 2) above with higher carton |
| | | quanity |
| S_{upright} | Integer | Number of stacks allowed for carton placed in its |
| | | upright orientation; also includes any placed on top |
| | | at other orientations. Value is one (1) or greater; one |
| | | being nothing can stack on top, two being itself plus |
| | | one or more carton stacked on top, three being itself |
| | | plus two more cartons stacked on top, and logic |
| | | follows . . . |
| S_{back} | Integer | Number of stacks allowed for carton laid on its |
| | | front/back, meaing W_{ctn} becomes the upright |
| | | orientation. Zero (0) for not allowed stacking, while |
| | | 1 or greater is the maximum stacked allowed for |
| | | cartons to be stacked all laid on front/back. |
| S_{side} | Integer | Number of stacks allowed for carton laid on its |
| | | side/end, meaning L_{ctn} becomes the upright |
| | | orientation. Zero (0) for not allowed stacking, while |
| | | 1 or greater is the maximum stacks allowed for |
| | | cartons to be stacked all laid on side/end. |

### Recursive Allocation Method & Two Blocks System

For the allocation by geometry, a way to determine the maximum quantity of homogeneous dispatch load units that can be packed into a container load unit is by a Recursive Allocation Method. This method is desirable, as packing cubical objects into a cubical space often cannot achieve 100% utilization. After packing objects into a cubical space in a certain orientation, residual cubical spaces result and may be further packed by objects in different orientations or of different sizes. Based on common warehouse packing preferences, the packing is a recursive process first packing objects in upright orientations and then where allowed may further pack residual spaces by objects in non-upright orientations. Here, a cubical object represents a dispatch load unit or a carton, and a cubical space represents the interior space of a container load unit.

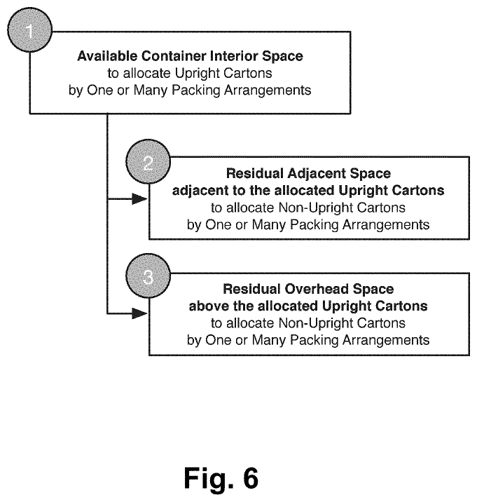

The recursive allocation method starts with a given cubical spatial unit, after it is fully allocated with homogeneous cubical objects in upright orientation, two residual spaces result that may further allocate the same homogeneous cubical objects in non-upright orientations. These residual spaces are the overhead and adjacent spaces around the body of upright objects. Each of these residual spaces, in the form of a cubical spatial unit, may apply the allocation method again; each will result in smaller overhead and adjacent residual cubical spacial units for further allocation, FIG. 6. Although it is mathematically possible to recursively allocate to successive residual spatial units, here the allocation method stops after allocated the first round of overhead and adjacent spaces, as subsequent residual spaces are insignificant. More importantly, when objects are in non-upright orientations, packing preference prohibits further stacking on top of non-upright objects.

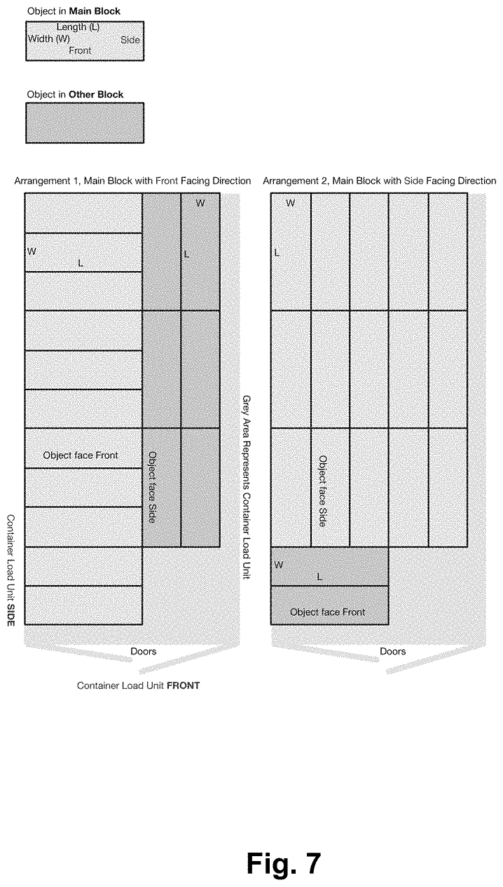

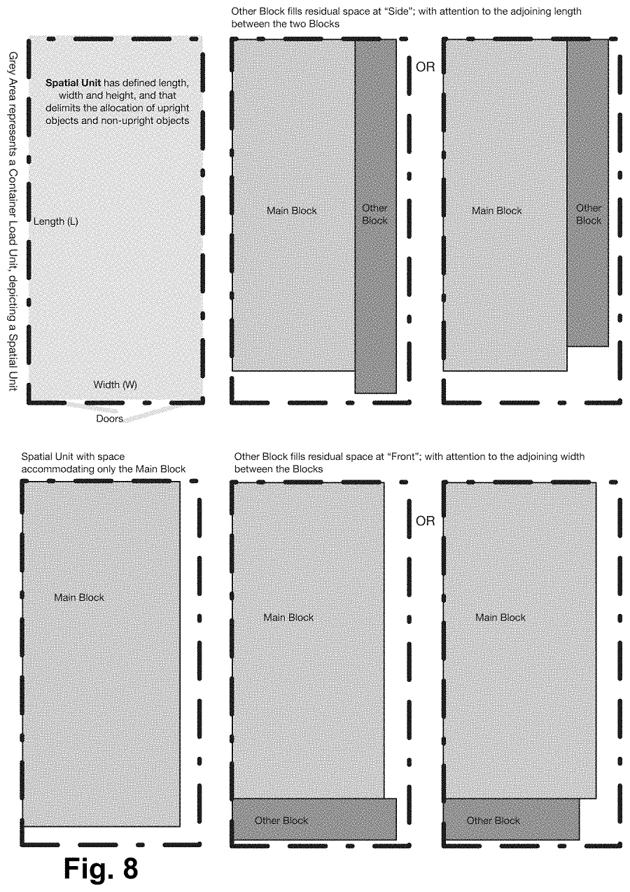

For a spatial unit, the allocation method applies allocation by a two block system, in the form of a main object block and the other object block, both a cubical block, to fill the space, ref FIG. 7. Each block consists of objects all with identical placement orientation and are tightly packed or abutted. The main block is the primary allocation block to fill the spatial unit. The other block, adjacent to the main block with different placement orientation, is to fill residual space in the form of a cubical spatial unit. If the objects at the main block are facing the front of the spatial unit, then the objects at the other block will be facing the side of the spatial unit; and vice versa. The main block will fill the spatial unit until no more can be allocated; the other block may only exist if the main block exists and the residual adjacent space is large enough to allocate, whereupon the other block will fill the residual adjacent cubical space until no more can be allocate as well. Together, the blocks attempt to fill the spatial unit with high utilization. Based on geometry, ref. FIG. 8, with the main block placed against the sides of the spatial unit, the main block may result with two possible residual adjacent locations, one along the side and the other along the front. Since the objects and the blocks are cubical, only up to one residual adjacent space can be allocated by the other block. There can be three possible outcomes in allocating the other block as follow. The two blocks allocation system picks the allocation with the highest quantity of objects.
a. The other block along the side of main block
b. The other block along the front of main block
c. The adjacent space is not large enough so the other block does not exist

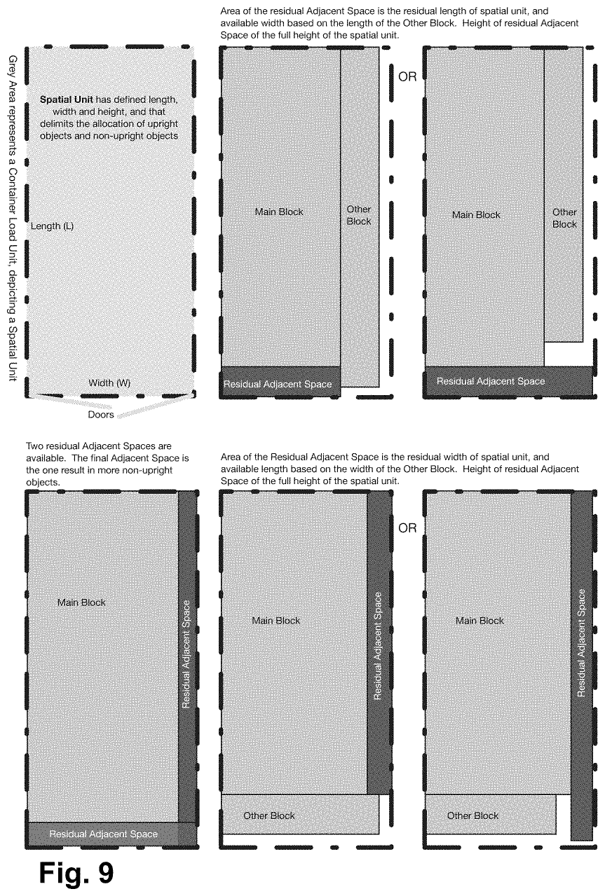

For the commencing spatial unit is allocated, the residual overhead and adjacent spatial dimensions can be determined for follow-on allocation, ref FIG. 9. The residual adjacent spatial unit is one not occupied by the other block with the largest rectangular area possible with a full spatial unit height. The residual overhead spatial unit is one with the largest rectangular area possible. It is the area of the main block, but may span the main block and the other block if both blocks have the same height. The overhead spatial unit height is of the remaining overhead height. The allocation of these residual spaces is again by the two blocks system.

The commencing spatial unit is to be allocated by upright objects.

The adjacent spatial unit and overhead spatial unit are to be allocated by non-upright objects.

The quantity of upright objects allocated in the spatial unit, and the quantity of non-upright objects allocated in the overhead spatial unit and adjacent spatial unit are summed to give the total Allocable Quantity (Q) of the object to the spatial unit.

### Spatial Unit Representing a Container Load Unit

For the application of the recursive allocation method, the properties of a spatial unit are listed at Table III.

TABLE III

| Property | Type | Description |
|---|---|---|
| L_{S} | Decimal | Length of the cubical spatial unit between the back |
| | | and the front |
| W_{S} | Decimal | Width of the cubical spatial unit between the left and |
| | | the right sides |
| H_{S} | Decimal | Height of the cubical spatial unit between the top |
| | | and bottom |

The commencing spatial unit, ref. Table IV, is simply the usable dimension of the container load unit. This is the interior container dimension less any reserved for lost space from loose packing, ref. Table I.

TABLE IV

| | Business | | |
|---|---|---|---|
| Parameter | Rule | Type | Description |
| L_{S} | L_{ctr} − Lᵣₑₛₑᵣᵥₑ | Decimal | Length of the commencing spatial |
| | | | unit |
| W_{S} | W_{ctr} − Wᵣₑₛₑᵣᵥₑ | Decimal | Width of the commencing spatial |
| | | | unit |
| H_{S} | H_{ctr} − Hᵣₑₛₑᵣᵥₑ | Decimal | Height of the commencing spatial |
| | | | unit |

The spatial unit dimensions of subsequent residual overhead and adjacent spatial units around the upright object blocks can only be determined after the upright object blocks are calculated.

### Allocation of Dispatch Load Unit

For the allocating object and its placement orientation, it is represented by dimensions so when a carton is intended to have a specific placement orientation, the length, width and height of the carton is assigned accordingly to the length, width and height of the main block object and that of the other block object.

The allocating objects for the main block and the other block can be modeled by a number of properties, ref. Table V, for allocating in spatial unit; also on properties for stacking objects on top of the object blocks below.

TABLE V

| Main | Other | | |
|---|---|---|---|
| Block | Block | | |
| Property | Property | Type | Description |
| Lᵤ₁ | Lᵤ₂ | Decimal | Front width of the carton unit; between the |
| | | | left and right side of the carton. |
| Wᵤ₁ | Wᵤ₂ | Decimal | Side width of the carton unit; between the |
| | | | front and back of the carton. |
| Hᵤ₁ | Hᵤ₂ | Decimal | Height of the carton unit; between the top |
| | | | and the bottom of the carton. |
| S_{current1} | S_{current2} | Integer | Stacking limit of the current spatial unit |
| Sₜₒₜₐₗ₁ | Sₜₒₜₐₗ₂ | Integer | Overall stacking limit (current spatial unit |
| | | | and below spatial unit) |
| S_{below1} | S_{below2} | Integer | Stacks stacked below current spatial unit |

Objects for the main block and other block are separately identified in the Two Blocks System so they maybe separately modeled and applied in the algorithm on the allocation calculation.

### Allocation of Upright Objects

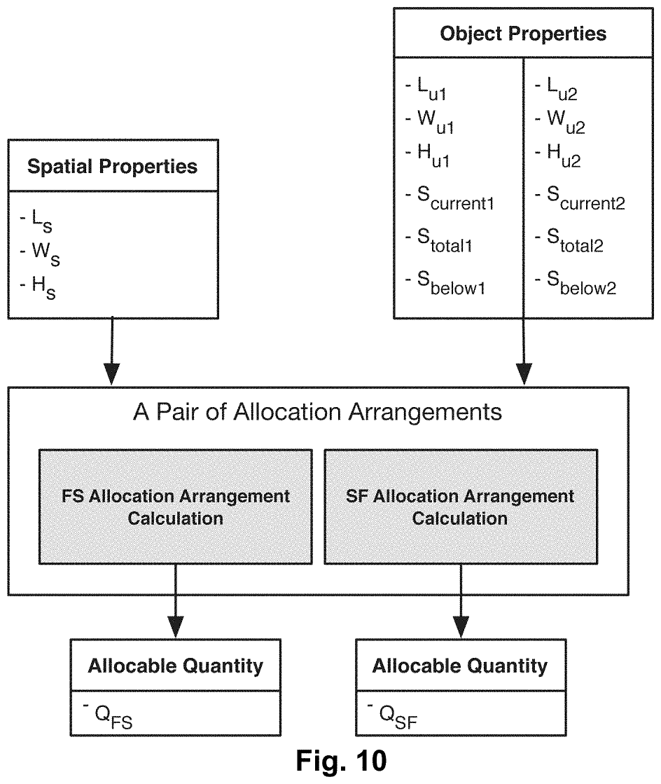

For allocating upright dispatch load unit into the commencing spatial unit, two allocation arrangements (FS and SF) are possible. One with main block objects facing front (F), another with main block objects facing side (S). The two blocks system correspondingly will have the objects at the other block turned to face the other direction; see Table VI. Each allocation arrangement will produce its recursive allocation result. The carton loading property (D_{facing}) at Table II, will determine the Allocable Quantity (Q) is from which upright arrangement, ref FIG. 10.

TABLE VI

| | | Main Block | | Other Block | |
|---|---|---|---|---|---|
| # | Arrangement | Orientation | Facing | Orientation | Facing |
| 1 | FS | Upright | Front | Upright | Side |
| | SF | Upright | Side | Upright | Front |

Upright objects in the commencing spatial unit, with the two allocation arrangements are modelled in Table VII. The objects at the main block and the other block are identical except for their facing direction. The algorithm will manipulate Lᵤ₂ and Wᵤ₂ accordingly to represent the object rotation about the y-axis in the Cartesian coordinate system for the change in facing direction. The carton length, width and height are mapped to the object length, width and height according to their placement orientation arrangement. The maximum stacking of the current spatial unit (S_{current}) is that of the upright carton. Since there is no cartons stacked below (S_{below}), the maximum total stacking (Sₜₒₜₐₗ) remains to be that of upright carton.

TABLE VII

| | | Main Block | | | | | | | Other Block | | | | | | |
|---|---|---|---|---|---|---|---|---|---|---|---|---|---|---|---|
| # | | Orientation | Lᵤ₁ | Wᵤ₁ | Hᵤ₁ | S_{current1} | Sₜₒₜₐₗ₁ | S_{below1} | Orientation | Lᵤ₂ | Wᵤ₂ | Hᵤ₂ | S_{current2} | Sₜₒₜₐₗ₂ | S_{below2} |
| 1 | FS | Upright | L_{ctn} | W_{ctn} | H_{ctn} | S_{upright} | S_{upright} | 0 | Upright | L_{ctn} | W_{ctn} | H_{ctn} | S_{upright} | S_{upright} | 0 |
| | SF | Upright | W_{ctn} | L_{ctn} | H_{ctn} | S_{upright} | S_{upright} | 0 | Upright | W_{ctn} | L_{ctn} | H_{ctn} | S_{upright} | S_{upright} | 0 |

### Allocation of Non-Upright Objects

Non-upright objects to be allocated to the residual overhead and adjacent cubical spatial units have a number of orientation combinations are modeled in Table VIII. Since the non-upright orientations are carton lying on its front/back face and lying on its side face, there are total of four combinations, each has two facing arrangements (FS and SF).

TABLE VIII

| | | Main Block | | Other Block | |
|---|---|---|---|---|---|
| # | Arrangement | Orientation | Facing | Orientation | Facing |
| 1 | FS | Lay on Back | Front | Lay on Back | Side |
| | SF | Lay on Back | Side | Lay on Back | Front |
| 2 | FS | Lay on Side | Front | Lay on Side | Side |
| | SF | Lay on Side | Side | Lay on Side | Front |
| 3 | FS | Lay on Back | Front | Lay on Side | Side |
| | SF | Lay on Back | Side | Lay on Side | Front |
| 4 | FS | Lay on Side | Front | Lay on Back | Side |
| | SF | Lay on Side | Side | Lay on Back | Front |

Based on the carton dimensions, the non-upright objects allocation combination model can be referenced at Table IX. Carton dimensions are assigned to the appropriate object dimension to represent the required carton placement orientation.

TABLE IX

| | | Main Block | | | | Other Block | | | |
|---|---|---|---|---|---|---|---|---|---|
| # | | Orientation | Lᵤ₁ | Wᵤ₁ | Hᵤ₁ | Orientation | Lᵤ₂ | Wᵤ₂ | Hᵤ₂ |
| 1 | FS | on Back | L_{ctn} | H_{ctn} | W_{ctn} | on Back | L_{ctn} | H_{ctn} | W_{ctn} |
| | SF | on Back | H_{ctn} | L_{ctn} | W_{ctn} | on Back | H_{ctn} | L_{ctn} | W_{ctn} |
| 2 | FS | on Side | H_{ctn} | W_{ctn} | L_{ctn} | on Side | H_{ctn} | W_{ctn} | L_{ctn} |
| | SF | on Side | W_{ctn} | H_{ctn} | L_{ctn} | on Side | W_{ctn} | H_{ctn} | L_{ctn} |
| 3 | FS | on Back | L_{ctn} | H_{ctn} | W_{ctn} | on Side | H_{ctn} | W_{ctn} | L_{ctn} |
| | SF | on Back | H_{ctn} | L_{ctn} | W_{ctn} | on Side | W_{ctn} | H_{ctn} | L_{ctn} |
| 4 | FS | on Side | H_{ctn} | W_{ctn} | L_{ctn} | on Back | L_{ctn} | H_{ctn} | W_{ctn} |
| | SF | on Side | W_{ctn} | H_{ctn} | L_{ctn} | on Back | H_{ctn} | L_{ctn} | W_{ctn} |

The loading property of the carton may limit whether a carton can be placed lying on its front/back face (S_{back}) and lying on its side face (S_{side}), as can be referenced in Table II.

For non-upright cartons to allocate to the residual adjacent space, the object property is modelled in Table X. The maximum stacking at the current spatial unit (_{Scurrent}) is that of the carton stacking property of its lying orientation. Since the cartons are to be allocated at the adjacent spatial unit, they are placed on the base of the spatial unit; so maximum total stacking (Sₜₒₜₐₗ) is the same as the maximum stacking at the current spatial unit. There are no cartons stacked below (S_{below}).

TABLE X

| | | Main Block | | | | | | | Other Block | | | | | | |
|---|---|---|---|---|---|---|---|---|---|---|---|---|---|---|---|
| # | | Orientation | Lᵤ₁ | Wᵤ₁ | Hᵤ₁ | S_{current1} | Sₜₒₜₐₗ₁ | S_{below1} | Orientation | Lᵤ₂ | Wᵤ₂ | Hᵤ₂ | S_{current2} | Sₜₒₜₐₗ₂ | S_{below2} |
| 1 | FS | on Back | L_{ctn} | H_{ctn} | W_{ctn} | S_{back} | S_{back} | 0 | on Back | L_{ctn} | H_{ctn} | W_{ctn} | S_{back} | S_{back} | 0 |
| | SF | on Back | H_{ctn} | L_{ctn} | W_{ctn} | S_{back} | S_{back} | 0 | on Back | H_{ctn} | L_{ctn} | W_{ctn} | S_{back} | S_{back} | 0 |
| 2 | FS | on Side | H_{ctn} | W_{ctn} | L_{ctn} | S_{side} | S_{side} | 0 | on Side | H_{ctn} | W_{ctn} | L_{ctn} | S_{side} | S_{side} | 0 |
| | SF | on Side | W_{ctn} | H_{ctn} | L_{ctn} | S_{side} | S_{side} | 0 | on Side | W_{ctn} | H_{ctn} | L_{ctn} | S_{side} | S_{side} | 0 |
| 3 | FS | on Back | L_{ctn} | H_{ctn} | W_{ctn} | S_{back} | S_{back} | 0 | on Side | H_{ctn} | W_{ctn} | L_{ctn} | S_{side} | S_{side} | 0 |
| | SF | on Back | H_{ctn} | L_{ctn} | W_{ctn} | S_{back} | S_{back} | 0 | on Side | W_{ctn} | H_{ctn} | L_{ctn} | S_{side} | S_{side} | 0 |
| 4 | FS | on Side | H_{ctn} | W_{ctn} | L_{ctn} | S_{side} | S_{side} | 0 | on Back | L_{ctn} | H_{ctn} | W_{ctn} | S_{back} | S_{back} | 0 |
| | SF | onSide | W_{ctn} | H_{ctn} | L_{ctn} | S_{side} | S_{side} | 0 | on Back | H_{ctn} | L_{ctn} | W_{ctn} | S_{back} | S_{back} | 0 |

For non-upright cartons to allocate to the residual overhead space, the object property is modelled in Table XI. The maximum stacking at the current spatial unit (S_{current}) is that of the carton stacking property of its lying orientation. Since the cartons are to be allocated on top of the upright cartons, so maximum total stacking (Sₜₒₜₐₗ) is that of the upright cartons, which cannot be exceeded. The cartons stacked below (S_{below}) is the calcuated stacked count (Sₘ) of the upright carton block, arbitrarily referencing that of the main block.

TABLE XI

| | | Main Block | | | | | | | Other Block | | | | | | |
|---|---|---|---|---|---|---|---|---|---|---|---|---|---|---|---|
| # | | Orientation | Lᵤ₁ | Wᵤ₁ | Hᵤ₁ | S_{current1} | Sₜₒₜₐₗ₁ | S_{below1} | Orientation | Lᵤ₂ | Wᵤ₂ | Hᵤ₂ | S_{current2} | Sₜₒₜₐₗ₂ | S_{below2} |
| 1 | FS | on Back | L_{ctn} | H_{ctn} | W_{ctn} | S_{back} | S_{upright} | Sₘ | on Back | L_{ctn} | H_{ctn} | W_{ctn} | S_{back} | S_{upright} | Sₘ |
| | SF | on Back | H_{ctn} | L_{ctn} | W_{ctn} | S_{back} | S_{upright} | Sₘ | on Back | H_{ctn} | L_{ctn} | W_{ctn} | S_{back} | S_{upright} | Sₘ |
| 2 | FS | on Side | H_{ctn} | W_{ctn} | L_{ctn} | S_{side} | S_{upright} | Sₘ | on Side | H_{ctn} | W_{ctn} | L_{ctn} | S_{side} | S_{upright} | Sₘ |
| | SF | on Side | W_{ctn} | H_{ctn} | L_{ctn} | S_{side} | S_{upright} | Sₘ | on Side | W_{ctn} | H_{ctn} | L_{ctn} | S_{side} | S_{upright} | Sₘ |
| 3 | FS | on Back | L_{ctn} | H_{ctn} | W_{ctn} | S_{back} | S_{upright} | Sₘ | on Side | H_{ctn} | W_{ctn} | L_{ctn} | S_{side} | S_{upright} | Sₘ |
| | SF | on Back | H_{ctn} | L_{ctn} | W_{ctn} | S_{back} | S_{upright} | Sₘ | on Side | W_{ctn} | H_{ctn} | L_{ctn} | S_{side} | S_{upright} | Sₘ |
| 4 | FS | on Side | H_{ctn} | W_{ctn} | L_{ctn} | S_{side} | S_{upright} | Sₘ | on Back | L_{ctn} | H_{ctn} | W_{ctn} | S_{back} | S_{upright} | Sₘ |
| | SF | on Side | W_{ctn} | H_{ctn} | L_{ctn} | S_{side} | S_{upright} | Sₘ | on Back | H_{ctn} | L_{ctn} | W_{ctn} | S_{back} | S_{upright} | Sₘ |

### Allocation by Geometry Calculation Approach

The calculation logic of the Allocation by Geometry is structured as follow:
1. Determine the allocable quantity of upright objects at the commencing spatial unit. The steps are:
   a. Based on Table IV for the commencing spatial unit and Table VII for upright objects allocation arrangements, each arrangement calculates its allocable quantity, ref FIG. 10.
   b. Each upright object allocation arrangement also returns the dimensions of its residual adjacent and overhead spatial units to be used in the following steps.
2. Determine the allocable quantity of the non-upright objects at the residual adjacent spatial unit. The steps are:
   a. Based on the residual adjacent dimensions derived from step 1 above and Table X for non-upright objects allocation arrangements at the residual adjacent spatial unit, each arrangement calculates its allocable quantity and ignores the derived spatial units, ref FIG. 10.
   b. Select the single highest allocable quantity for the adjacent allocable quantity.
3. Determine the allocable quantity of the non-upright objects at the residual overhead spatial unit. The steps are:
   a. Based on the residual overhead dimensions derived from step 1 above and Table XI for non-upright objects allocation arrangements at the residual overhead spatial unit, each arrangement calculates its allocable quantity and ignores the derived spatial units, ref FIG. 10.
   b. Select the single highest allocable quantity for the overhead allocable quantity.
4. For each allocation arrangement of Table VII at step 1 above, sum all the allocable quantities of each spatial unit to produce the total Allocable Quantity by Geometry (Q_{G}). This is the maximum objects that can be allocated to the commencing spatial unit for each allocation arrangement of Table VII.
5. For the commencing spatial unit, the Allocable Quantity (Q_{G}) of which allocation arrangement will be selected is based on the object's loading property (D_{facing}) at Table II.

For determining allocable quantity of an object into a spatial unit, with the given properties of the object for the main block and the other block, the allocation quantity calculation logic is as follows, ref. FIG. 8:
a. Determine the maximum quantity of objects in the main block (Q_{M}).
b. If the main block exists, the other block can be determined; else there is no allocation to the spatial unit. The maximum quantity of objects in the other block (Q_{N}) are determined for both adjacent locations of the main block; at the side (S_{S}) and at the front (S_{F}). The location with the larger quantity is selected. It is also possible both adjacent locations may result in having no objects.
c. With the main block and the other block determined (Q_{M} & Q_{N}), ref. FIG. 9, all residual cubical spatial units and dimensions around the main block and the other block can be identified and have their dimensions determined for subsequent recursive allocation.
d. If the other block exists, ref. FIG. 9, the residual adjacent spatial unit is the location adjacent to the main block not occupied by the other block. This adjacent spatial unit is the largest cubical space of the remaining dimension not occupied by the main block and the other block, with the full spatial unit height. If the other block does not exist, two residual adjacent spatial units result; one at the front and the other at the side. Each is the largest cubical space of the remaining dimension not occupied by the main block. Subsequent recursive allocation will determine which of the two adjacent space will have the larger allocated object quantity and the larger is selected.
e. For the residual overhead spatial unit, ref. FIG. 9, if the other block does not exist, the overhead spatial unit will have the rectanglar area same as that of the main block. If the other block exists, and at the adjoining side with the main block, if the length of the other block is equal or greater then that of the main block, then the overhead rectangular spatial area will extend to include the other block. The overhead spatial height is the residual height of the main block to the top of the spatial unit.

### An Illustrated Example of Calculating the Allocable Quantity

With a given set of spatial unit properties, ref. Table IV, Table XV, Table XVIII, Table XX, Table XXI and allocating objects properties organized in an allocation arrangement, ref. Table VII, Table X, Table XI, the main block allocable quantity (Q_{M}) can be calculated as shown in Table XII. For the quotient in the calculations, only the integer value is preserved; the fraction is ignored.

TABLE XII

| Parameter | Business Rule | Type | Description |
|---|---|---|---|
| R_{M} | Lₛ/Wᵤ₁ | Integer | Rows at main block M |
| C_{M} | Wₛ/Lᵤ₁ | Integer | Columns at main block M |
| S_{M} | 1. Hₛ/Hᵤ₁ | Integer | Stacks at main block M. Cannot exceed stacking |
| | 2. If S_{M} > S_{current1} then set S_{M} = S_{current1} | | limit specified S_{current1}. Also overall stacks cannot |
| | 3. If (S_{M} + S_{below1}) > Sₜₒₜₐₗ₁ then set | | exceed overall carton stacking limit Sₜₒₜₐₗ₁. |
| | S_{M} = Sₜₒₜₐₗ₁ − S_{below1} | | Note, if S_{current1} = 0, then S_{M} = 0 and Q_{M} = 0. |
| Q_{M} | R_{M} * C_{M} * S_{M} | Integer | Carton quantity of the base main block M |

Since Q_{M} is calculated from the product of rows (R), columns (C) and stacks (S), if any has a value of zero (0), then Q_{M} is zero (0) and the block does not exist. Note for stacks, the object stacking property may be constrained so the calculated stack value can be constrained, can even be constrained to zero (0).

With the main block allocable quantity determined and non-zero, the other block (Q_{N}) may exist at two locations, one at the side (Q_{S}), another at the front (Q_{F}) of the main block, ref FIG. 8. Both are calculated and then determine which is selected. Correspondingly, based on the other block selected, then determine the residual adjacent and overhead spatial units for recursive allocation quantity calculation, ref., FIG. 9.

The other block adjacent to the side (S) of the main block can be determined only if the main block exists (Q_{M} not equal zero). The spatial dimension at the side can be determined as shown in Table XIII. The allocable quantity (Q_{S}) for the other block at the side can be calculated as shown in Table XIV. Again, for the quotient in the calculations, only the integer value is preserved; the fraction is ignored. The corresponding residual front adjacent spatial unit (S_{SF}) can be determined at Table XV for subsequent recursive allocation.

TABLE XIII

| Parameter | Business Rule | Type | Description |
|---|---|---|---|
| L_{SS} | Lₛ | Decimal | Full dimension |
| W_{SS} | Wₛ − C_{M} * Lᵤ₁ | Decimal | Full width less width of main block |
| H_{SS} | Hₛ | Decimal | Full dimension |

TABLE XIV

| Parameter | Business Rule | Type | Description |
|---|---|---|---|
| R_{S} | L_{SS}/Lᵤ₂ | Integer | Rows at side block S |
| C_{S} | W_{SS}/Wᵤ₂ | Integer | Columns at side block S |
| S_{S} | 1. H_{SS}/Hᵤ₂ | Integer | Stacks at main block S. Cannot exceed stacking |
| | 2. If S_{S} > S_{current2} then set S_{S} = S_{current2} | | limit specified S_{current2}. Also overall stacks cannot |
| | 3. If (S_{S} + S_{below2}) > Sₜₒₜₐₗ₂ then set | | exceed overall carton stacking limit Sₜₒₜₐₗ₂. |
| | S_{S} = Sₜₒₜₐₗ₂ − S_{below2} | | Note, if S_{current2} = 0, then S_{S} = 0 and Q_{S} = 0. |
| Q_{S} | R_{S} * C_{S} * S_{S} | Integer | Carton quantity of the base main block S |

TABLE XV

| Parameter | Business Rule | Type | Description |
|---|---|---|---|
| L_{SSF} | Lₛ − R_{M} * Wᵤ₁ | Decimal | Full length less length of main block |
| W_{SSF} | If (Rₛ − Lᵤ₂ > R_{M} * Wᵤ₁) | Decimal | Width is main block width when length of the |
| | then set W_{SSF} = C_{M} * Lᵤ₁ | | other block is greater than length of the man |
| | else set W_{SSF} = Wₛ | | block, else width is full width of spatial unit. |
| H_{SSF} | H_{S} | Decimal | Full dimension |

The other block adjacent to the front (F) of the main block can be determined only if the main block exists. The spatial dimension at the front can be determined as shown in Table XVI. The allocable quantity (Q_{F}) for the other block at the front can be calculated as shown in Table XVII. Again, for the quotient of the calculations, only the integer value is preserved; the fraction is ignored. The corresponding residual side adjacent spatial unit (S_{FS}) can be determined at Table XVIII for subsequent allocation is shown.

TABLE XVI

| Parameter | Business Rule | Type | Description |
|---|---|---|---|
| L_{SF} | Lₛ − R_{M} * Wᵤ₁ | Decimal | Full length less length of main block |
| W_{SF} | Wₛ | Decimal | Full dimension |
| H_{SF} | Hₛ | Decimal | Full dimension |

TABLE XVII

| Parameter | Business Rule | Type | Description |
|---|---|---|---|
| R_{F} | L_{SF}/Lᵤ₂ | Integer | Rows at side block F |
| C_{F} | W_{SF}/Wᵤ₂ | Integer | Columns at side block F |
| S_{F} | 1. H_{SF}/Hᵤ₂ | Integer | Stacks at main block F. Cannot exceed stacking |
| | 2. If S_{F} > S_{current2} then set S_{F} = S_{current2} | | limit specified S_{current2}. Also overall stacks cannot |
| | 3. If (S_{F} + S_{below2}) > Sₜₒₜₐₗ₂ then set | | exceed overall carton stacking limit Sₜₒₜₐₗ₂. |
| | S_{F} = Sₜₒₜₐₗ₂ − S_{below2} | | Note, if S_{current2} = 0, then S_{F} = 0 and Q_{F} = 0. |
| Q_{F} | R_{F} * C_{F} * S_{F} | Integer | Carton quantity of the base main block F |

TABLE XVIII

| Parameter | Business Rule | Type | Description |
|---|---|---|---|
| L_{SFS} | If (C_{F} * Wᵤ₂ > C_{M} * Lᵤ₁) | Decimal | Length is main block |
| | then set L_{SFS} = R_{M} * Wᵤ₁ | | length when width of |
| | else set L_{SFS} = Lₛ | | the other block is greater |
| | | | than width of the main |
| | | | block, else length is the |
| | | | full length of the spatial |
| | | | unit |
| W_{SFS} | W_{S} − C_{M} * Lᵤ₁ | Decimal | Full width less width of |
| | | | main block |
| H_{SFS} | H_{S} | Decimal | Full dimension |

Overhead spatial unit can be determined only if the main block exists. For the main block without the other block, the overhead spatial unit (S_{O}) is shown in Table XIX. For the other block exists at the side of the main block, the overhead spatial unit (S_{SO}) is shown in Table XX. For the other block exists at the front of the main block, the overhead spatial unit (S_{R})) is shown in Table XXI.

TABLE XIX

| Parameter | Business Rule | Type | Description |
|---|---|---|---|
| L_{SO} | R_{M} * Wᵤ₁ | Decimal | Length of the main block. |
| W_{SO} | C_{M} * Lᵤ₁ | Decimal | Width of the main block. |
| H_{SO} | H_{S} − S_{M} * Hᵤ₁ | Decimal | Full height less height of |
| | | | main block |

TABLE XX

| Parameter | Business Rule | Type | Description |
|---|---|---|---|
| L_{SSO} | R_{M} * Wᵤ₁ | Decimal | Length of the main |
| | | | block |
| W_{SSO} | If (R_{S} * Lᵤ₂ >= R_{M} * Wᵤ₁) | Decimal | Width of main block |
| | then set W_{SSO} = | | plus width of the |
| | C_{M} * Lᵤ₁ + C_{S} * Wᵤ₂ | | other block when |
| | else set W_{SSO} = C_{M} * Lᵤ₁ | | length of the other |
| | | | block is equal or |
| | | | greater than length |
| | | | of the man block, |
| | | | else width is width |
| | | | of the main block. |
| H_{SSO} | H_{S} − S_{M} * Hᵤ₁ | Decimal | Full height less |
| | | | height of main block |

TABLE XXI

| Parameter | Business Rule | Type | Description |
|---|---|---|---|
| L_{SFO} | If (C_{F} * Wᵤ₂ >= CM * Lᵤ₁) | Decimal | Length of main |
| | then set L_{SFO} = | | block plus length of |
| | R_{M} * Wᵤ₁ + R_{F} * Lᵤ₂ | | the other block when |
| | else set L_{SFO} = R_{M} * Wᵤ₁ | | width of the other |
| | | | block is equal or |
| | | | greater than width of |
| | | | the man block, else |
| | | | length is length of |
| | | | the main block. |
| W_{SFO} | C_{M} * Lᵤ₁ | Decimal | Width of the main |
| | | | block |
| H_{SFO} | H_{S} − S_{M} * Hᵤ₁ | Decimal | Full height less |
| | | | height of main |
| | | | block |

Table XXII summarises the calculation of the Recursive Allocation Method and the Two Blocks System from the commencing spatial unit through all the subsequent residual cubical spatial units to the determination of the final allocable quantity (Q_{G}). Each table column shows the cubical spatial unit to calculate in the recursive calculation process. The table rows show the calculation inputs and outputs. The input being the properties of the spatial unit and allocation arrangements possible for the spatial unit. The calculation outputs are for each allocation arrangement; are the allocation quantity for the main block (Q_{M}), the two allocation quantity possible of the other blocks (Q_{N}), the two possible corresponding adjacent cubical spatial units and the two possible corresponding overhead cubical spatial units. Each calculation references the Table described in earlier sections that has the calculation details. The table also shows three column groups of spatial units. First is the commencing spatial unit (single column) that initiates the calculation process representing a container load unit and for upright objects. Second group (two columns) is based on the result of the first column is of the recursive residual spatial units when the other block (Q_{N}) is at the side of the main block. The residual spatial units are the adjacent spatial unit at the front (S_{SF}) and at the overhead (S_{SO}) Third group (two columns) is based on the result of the first column is of the recursive residual spatial units when the other block (Q_{N}) is at the front of the main block. The residual spatial units are the adjacent spatial unit at the side (S_{FS}) and at the overhead (S_{FO}). Second and third column groups are for non-upright allocating objects. Do note each spatial unit column has its allocation arrangements listed in each of their table, which means each arrangement will have its one set of output, and lead to its follow on recursive calculation in the second and third column groups. Per spatial unit column, only the largest total quantity of all the allocation arrangements is returned.

TABLE XXII

| | | For the Other Block Q_{N}@Side | | For the Other Block Q_{N}@Front | |
|---|---|---|---|---|---|
| | | Adjacent | Overhead | Adjacent | Overhead |
| | Commencing | Spatial Unit | Spatial Unit | Spatial Unit | Spatial Unit |
| | Spatial Unit | (S_{SF}) | (S_{SO}) | (S_{FS}) | (S_{FO}) |
| Spatial Unit | Table IV | Table XV | Table XX | Table XVIII | Table XXI |
| Allocation | Table VII | Table X | Table XI | Table X | Table XI |
| Arrangements | | | | | |
| Object | Upright | Non-Upright | Non-Upright | Non-Upright | Non-Upright |
| Orientation | | | | | |
| Main Block | Q_{M} = Table XII | Q_{MS} = Table XII | Q_{MSO} = Table XII | Q_{MF} = Table XII | Q_{MFO} = Table XII |
| Quantity Q_{M} | | | | | |
| Other Block | Q_{S} = Table XIV | Q_{SS} = Table XIV | Q_{SSO} = Table XIV | Q_{SF} = Table XIV | Q_{SFO} = Table XIV |
| Quantity | | | | | |
| Q_{N} @Side | | | | | |
| Other Block | Q_{F} = Table XVII | Q_{FS} = Table XVII | Q_{FSO} = Table XVII | Q_{FF} = Table XVII | Q_{FFO} = Table XVII |
| Quantity | | | | | |
| Q_{N} @Front | | | | | |
| Total Quantity | Q_{B} = larger | Q_{SF} = larger | Q_{SO} = larger | Q_{FS} = larger | Q_{FO} = larger |
| per Allocation | of (Q_{M} + Q_{S}) | of (Q_{MS} + Q_{SS}) | of (Q_{MSO} + Q_{SSO}) | of (Q_{MF} + Q_{SF}) | of (Q_{MFO} + Q_{SFO}) |
| Arrangement | or (Q_{M} + Q_{F}) | or (Q_{MS} + Q_{FS}) | or (Q_{MSO} + Q_{FSO}) | or (Q_{MF} + Q_{FF}) | or (Q_{MFO} + Q_{FFO}) |
| Adjacent Space | S_{SF} = | n/a | n/a | n/a | n/a |
| Q_{N}@Side | Table XV | | | | |
| Adjacent Space | S_{FS} = | n/a | n/a | n/a | n/a |
| Q_{N}@Front | Table XVIII | | | | |
| Overhead Space | S_{SO} = | n/a | n/a | n/a | n/a |
| Q_{N}@Side | Table XX | | | | |
| Overhead Space | S_{FO} = | n/a | n/a | n/a | n/a |
| Q_{N}@Front | Table XXI | | | | |

Only the commencing spatial unit will determine the residual spatial units (S_{SF}, S_{FS}, S_{SO}, or S_{FO}). Based on the Packing Preference in practice at warehouses, after determining the Allocable Quantity of upright blocks at the commercing spatial unit, all residual spatial units for non-upright blocks (second and third column groups) will ignore their residual spatial units.

For each of the spatial unit column in Table XXII, when the main block (Q_{M}) calculation result in zero quantity, the spatial unit as a whole will return zero quantity. This means the other block (Q_{N}) will have zero quantity and no residual spatial units (S_{SF}, S_{FS}, S_{SO}, ^{or S}_{FO}).

For the commencing spatial unit with an allocation arrangement that lead to a main block (Q_{M}) with the other block (Q_{N}) at the side of the main block, the follow on adjacent spatial unit at the front (S_{SF}) and overhead spatial unit (S_{SO}) results, which will apply the second column group Adjacent Spatial Unit (S_{SF}) and Overhead Special Unit (S_{So}) for the non-upright cartons calculation. Each allocation arrangement of Table X will have a total quantity (Q_{SF}) which the largest of all allocation arrangements will be returned. Similarly, each allocation arrangement of Table XI will have a total quantity (Q_{SO}) which the largest of all allocation arrangements will be returned. The largest returned value of Q_{SF} and Q_{SO} will sum with Q_{B} to return the Q_{G} of the commencing spatial unit and the allocation arrangement.

For the commencing spatial unit with an allocation arrangement that lead to a main block (Q_{M}) with the other block (Q_{N}) at the front of the main block, the follow on adjacent spatial unit at the side (S_{FS}) and overhead spatial unit (S_{FO}) results, which will apply the third column group Adjacent Spatial Unit (S_{FS}) and Overhead Special Unit (S_{FO}) for the non-upright cartons calculation. Each allocation arrangement of Table X will have a total quantity (Q_{FS}) which the largest of all allocation arrangements will be returned. Similarly, each allocation arrangement of Table XI will have a total quantity (Q_{FO}) which the largest of all allocation arrangements will be returned. The largest returned value of Q_{FS} and Q_{FO} will sum with Q_{B} to return the Q_{G} of the commencing spatial unit and the allocation arrangement.

For the commencing spatial unit with an allocation arrangement that lead to a main block (Q_{M}) and without the other block (Q_{N}), the follow on adjacent spatial unit at the side (S_{SF}), adjacent spatial unit at the front (S_{FS}) and overhead spatial unit (S_{FO}) results, which will apply the column Adjacent Spatial Unit (S_{SF}), Adjacent Spatial Unit (S_{FS}) and Overhead Spatial Unit (S_{FO}) for the non-upright cartons calculation. Each allocation arrangement of Table X will have a total quantity (Q_{SF}) which the largest of all allocation arrangements will be returned. Each allocation arrangement of Table X will have a total quantity (Q_{FS}) which the largest of all allocation arrangements will be returned. Similarly, each allocation arrangement of Table XI will have a total quantity (Q_{FO}) which the largest of all allocation arrangements will be returned. The largest returned value between Q_{SF} and Q_{FS} and the largest return value of Q_{FO} will sum with Q_{B} to return the Q_{G} of the commencing spatial unit and the allocation arrangement. D_{O} note that Q_{G} may be determined based on Overhead Spatial Unit (S_{FO}) or (S_{SO}) as both are identical since the other block (Q_{N}) does not exist. Here, Overhead Spatial Unit (S_{FO}) is arbitrarily picked for illustration.

For the commencing spatial unit, two allocation arrangements exist, ref. Table VII, which will result in two allocable quantity Q_{G} values. Which allocable value is returned for the commencing spatial unit is governed by D_{facing} value of the allocating object, ref. Table II.

### Homogeneous Allocation Algorithm Extension

Empirical Adjustment of Allocable Quantity from Allocation by Geometry

User may want to override the Allocable Quantity (Q_{G}) with a preferred empirical value to result in a new Allocable Quantity (Q_{GE}), as referenced in FIG. 2 step 2. For no adjustment, then Q_{GE} =Q_{G}. The allocable quantity determined by Allocation by Geometry (Q_{G}) should be a physical allocable quantity upper limit. Any adjustment can only be a lower quantity value. The adjustment simply means the container load unit is to be packed with fewer dispatch load units so reducing utilization. In terms of unit conversion, the dispatch load unit to container load unit will have an adjusted lower conversion rate (Q_{GE}).

When subsequently the dispatch load unit is to be adopted by a product item, the item adopts the adjusted unit conversion ratio (Q_{GE}) of the dispatch load unit to the container load unit.

### Allocation by Weight (Q_{W})

Item may adopt one or more dispatch load units as its fulfillment and freighting units. With each dispatch load unit adoption, it is adopting a unit conversion (Q_{W}=Q_{GE}). As part of the adoption, the number of items to the dispatch load unit, and weight to have the dispatch load unit defined with a gross weight, all need to be specified, ref. FIG. 2 step 3. The item then has a unit conversion spanning item, dispatch load unit and container load unit. For the item adopted many dispatch load units, each has its own item to dispatch load unit to container load unit conversion rate, ref. FIG. 2 step 5.

For an item associated dispatch load unit, with its inherited Allocable Quantity (Q_{W}=Q_{GE}) and with a unit gross weight, the resultant allocated gross weight may exceed the container load unit maximum load limit. If user prefers not to respect this maximum load limit, then the inherited dispatch load unit Allocable Quantity requires no change; otherwise, it is lowered to the maximum quantity not exceeding the container's maximum load limit, as referenced in Table XXIII. Accordingly, Unit Allocable Volume (V_{W}) is recalculated.

TABLE XXIII

| Property | Business Rule | Type | Description |
|---|---|---|---|
| Q_{ctn} | M_{ctr}/M_{ctn} | Integer | Allocable Quantity (Q_{W}) for the |
| | | | item dispatch load unit based on |
| | | | gross weight of the item |
| | | | dispatch load unit M_{ctn}. Only |
| | | | return the integer value of the |
| | | | quotient in the calculation, the |
| | | | fractional part (or remainder) is |
| | | | ignored. |
| | | | If container maximum load is |
| | | | to be respected and Q_{ctn} is less |
| | | | than Q_{W}, then adopts Q_{ctn} as the |
| | | | item dispatch load unit's |
| | | | updated Allocable Quantity Q_{W} |
| | | | as instead of the Allocable |
| | | | Quantity Q_{GE} from Allocation |
| | | | by Geometry. |
| V_{W} | L_{ctr} * W_{ctr} * H_{ctr})/ | Decimal | Unit allocation volume of an |
| | Q_{W} | | item dispatch load unit based on |
| | | | the final item dispatch load unit |
| | | | Allocable Quantity. |

Empirical Adjustment of Allocable Quantity from Allocation by Weight

User may want to override the Allocable Quantity (Q_{W}) with a preferred empirical value to result in a new Allocable Quantity (Q_{WE}), as referenced in FIG. 2 step 4. For no adjustment, then Q_{WE}=Q_{W}. The allocable quantity (Q_{W}) determined by Allocation by Weight is an allocable quantity upper limit. Again, any adjustment can only be a lower quantity value. Once Allocable Quantity is overridden, the corresponding Unit Allocable Volume (V_{WE}) is recalculated.

The Allocable Quantity (Q_{WE}) for the item is the unit conversion between the item associated dispatch load unit and the container load unit. The Unit Allocable Volume (V_{WE}) for the item dispatch load unit is for use in the heterogeneous allocation algorithm.

### Packing Arrangement Details in a Container Load Unit

For a dispatch load unit to a container load unit, the details on rows, columns and stacks for each dispatch load unit block in each spatial unit can be presented for review and as a packing instruction for packing a container.

As the Allocable Quantity is reduced with an empirical value, the reduction may start from either the overhead (S_{SO}, or S_{FO}) or the adjacent (S_{SF}, S_{FS}) spatial unit as preferred. In either case, reduction starts at the other block (Q_{N}) before proceeding to the main block (Q_{M}). Only if all the quantity from the overhead and adjacent spatial unit are all reduced to zero can the upright blocks be reduced. At the upright block, again, reduction starts at the other block before proceed to the main block.

### Heterogeneous Allocation Algorithm Model

The aim of the heterogeneous allocation algorithm is to determine the minimum container load units (CLU) required for a given scenario, typically in the form of a transaction with a list of items, each with a specified dispatch load unit (DLU) and quantity. As the algorithm is dynamically applied, the algorithm will recalculate as the scenario is updated.

The algorithm is depicted in FIGS. 4A-4C where it calculates the CLU quantity in stages and the logic is influenced by the Packing Preferences. The whole process applies Item Allocation Lookup Table from the homogeneous allocation algorithm, ref. FIG. 2, to calculate CLU quantity. The last step of the calculation is to sum all the CLU quantities to return the total CLU quantity required for the scenario.

The algorithm preference is to use the Allocable Quantity (Q) to determine as much of the CLU quantity as possible. Only when the conditions to apply Allocable Quantity is exhausted will Allocable Volume (V), ref. FIG. 2, be used to calculate the last of the CLU quantity. If CLU maximum load limit is to be respected, then allocation by Allocable Volume will additionally ensure calculation enforce the weight limit.

The preference to use Allocable Quantity is the allocation quantity between a dispatch load unit and a container load unit is known, and often it is empirically tested and refined over time. Thus the calculation based on Allocable Quantity at sales will have become highly trustworthy by backoffice logistics, with calculated quantity is executable by backoffice.

Allocable Quantity is only used when all the dispatch load units being considered for allocating to a container load unit have identical allocation properties, which is the condition that the homogeneous allocation algorithm is applicable. The allocation properties are the dimensional and loading properties as can be referenced in Table II.

If the dispatch load units being considered for allocating to a container load unit do not have uniform allocation properties, allocation calcuation is by unit dispatch load unit Allocable Volume (V). Unlike Allocation by Allocable Quanity, allocation by Allocable Volume is an estimation. For the best possible estimation, Allocable Volume is only applied at the final stage of the heterogeneous allocation algorithm, ref. FIGS. 4A-4C. To ensure container quantity will not be underestimated, the last container load unit should not be too ambitiously allocated as typically practiced.

The heterogeneous allocation algorithm is a three steps model as referenced in FIGS. 4A-4C, and explained below:
1. Allocation by Allocable Quantity on Items—a scenario is presented in item lines, ref Table)(XIV. Individual line items, and item group of identical items with identical dispatch load unit, are allocated into full CLU quantities, with remainder quantity for follow on allocation. Packing preference most desire to have containers allocated with single item type. By end of this step, a CLU quantity sub-total results and no individual line item or item group has DLU quantity that can pack a full CLU.
2. Allocation by Allocable Quantity of Identical Allocation Properties—all line items with remaining DLU quantities are organized into groups of identical allocation properties, which can be called Item Queue. For line items that are identical and with identical dispatch load unit, are again grouped together as an item group with a super-DLU-Lot. Quantity are sorted, that can be in ascending or descending quantity based on preference. Since each Item Queue is consist of line items of identical allocation properties, each Item Queue has one Allocable Quantity. Each item queue applies allocation and result with full CLU quantity, with remainder DLU-Lot quantity for follow on allocation. Packing preference desires same allocation properties are packed together in a CLU. By end of this step, a CLU quantity sub-total results and no Item Queue has remaining DLU quantity that can pack a full CLU.
3. Allocation by Allocable Volume and Weight—all Item Queues are combined together into a single Item Queue for the final allocation. Line items in the Item Queue can have different allocation properties. Allocation is by unit dispatch load unit based on Allocable Volume. Identical line items with identical dispatch load unit are again grouped together into Item Group. All line item DLU-Lots are sorted, that can be in ascending or descending lot volume. CLU is packed by unit dispatch load unit until packing next DLU will exceed the CLU interior volume. If the CLU maximum load limit is respected, then if gross weight of all allocated DLUs is overloaded the CLU, then DLUs are unallocated in reverse order until the CLU is no longer overloaded. All DLUs in the Item Queue must be allocated to a CLU at the end of this allocation process. By the end of this step, a CLU quantity results. This quantity is summed with all CLU quantity sub-total from previous steps to return a total CLU quantity required for the given scenario.

### An Illustrated Example of Calculating the CLU Quantity

The heterogeneous allocating algorithm, ref FIGS. 4A-4C, for determining the minimum number of container load units to containerize a given list of items can be illustrated using Table)(XIV. Each item is defined with a dispatch load unit (DLU) and a dispatch load unit quantity (DLU Qty).

TABLE XXIV

| Item | DLU | DLU Qty |
|---|---|---|
| Item A | DLU1 | 3,350 |
| Item B | DLU1 | 430 |
| Item A | DLU1 | 1,100 |
| Item C | DLU2 | 5,600 |
| Item D | DLU3 | 750 |
| Item E | DLU2 | 15 |
| Item C | DLU2 | 25 |
| Item C | DLU2 | 350 |
| Item C | DLU2 | 450 |
| Item C | DLU2 | 400 |

### Allocation by Allocable Quantity on Item

Per FIGS. 4A-4C step 1, based on a specified container load unit, each item has a defined Allocable Quantity (Q) can be referenced from its Item Allocable Lookup Table, as shown in Table XXV.

Per FIGS. 4A-4C step 1 a, for each line, the Allocable Quantity Q value applied against the line item DLU Qty results in a number of full CLU quantity (Full CLU Qty) and remainder DLU quantity (Remainder DLU Qty) not filling a CLU.

TABLE XXV

| | | | | Full | Remainder |
|---|---|---|---|---|---|
| | | DLU | | CLU | DLU |
| Item | DLU | Qty | Q | Qty | Qty |
| Item A | DLU1 | 3,350 | 800 | 4 | 150 |
| Item B | DLU1 | 430 | 800 | 0 | 430 |
| Item A | DLU1 | 1,100 | 800 | 1 | 300 |
| Item C | DLU2 | 5,600 | 500 | 11 | 100 |
| Item D | DLU3 | 750 | 800 | 0 | 750 |
| Item E | DLU2 | 15 | 500 | 0 | 15 |
| Item C | DLU2 | 25 | 500 | 0 | 25 |
| Item C | DLU2 | 350 | 500 | 0 | 350 |
| Item C | DLU2 | 450 | 500 | 0 | 450 |
| Item C | DLU2 | 400 | 500 | 0 | 400 |
| Sub-Total | | | | 16 | |

Line 1 Item A has 3,350 DLU₁; with an Allocable Quantity Q of 800 results in 4 full CLU Qty and 150 remaining DLU Qty, which can be referred to as an DLU-lot. The same is applied to each line item to result in a Full CLU Qty sub-total of 16, and each line item DLU-Lot is unable to fill a CLU on its own.

Per FIGS. 4A-4C step 1 b, all line items with identical dispatch load units are grouped together and sorted, as shown in Table XXVI. The grouped DLU-Lots can be collectively called super-DLU-Lot. Item A has a super-DLU-Lot of 450 and Item C has 1325. The sorting can be in ascending or descending order. The sorting ultimately affects how an allocating item dispatch load unit quantity is split across two container load units when the whole quantity cannot be allocated into one CLU. The sorting here is arbitrarily set to descending.

TABLE XXVI

| Item | DLU | DLU-Lot |
|---|---|---|
| Item A | DLU1 | 300 |
| Item A | DLU1 | 150 |
| Item C | DLU2 | 450 |
| Item C | DLU2 | 400 |
| Item C | DLU2 | 350 |
| Item C | DLU2 | 100 |
| Item C | DLU2 | 25 |
| Item B | DLU1 | 430 |
| Item D | DLU3 | 750 |
| Item E | DLU2 | 15 |
| Sub-Total | | |

Per FIGS. 4A-4C step 1c, for Item A with Allocable Quantity Q of 800, its super-DLU-Lot of 450 is insufficient to allocate a full CLU. For Item C with Q of 500, its super-DLU-Lot of 1325 allocates to have 2 full CLUs, as shown in Table)(XVII. Since the allocation is based on the sorted order, ref Table XXVI, second and third line item of Item C are split corresponding to the sequence of the allocating CLU. Remaining line items of Item C with super-DLU-Lot quantity of 325 is left for follow on allocation.

TABLE XXVII

| Item | DLU | DLU-Lot | CLU |
|---|---|---|---|
| Item A | DLU1 | 300 | |
| Item A | DLU1 | 150 | |
| Item C | DLU2 | 450 | 1 |
| Item C | DLU2 | 50 | |
| Item C | DLU2 | 350 | 1 |
| Item C | DLU2 | 150 | |
| Item C | DLU2 | 200 | |
| Item C | DLU2 | 100 | |
| Item C | DLU2 | 25 | |
| Item B | DLU1 | 430 | |
| Item D | DLU3 | 750 | |
| Item E | DLU2 | 15 | |
| Sub-Total | | | 2 |

### Allocation by Allocable Quantity of Identical Allocation Properties

Per FIGS. 4A-4C step 2, all line item DLU-Lots are organized into groups with identical allocation properties, called Item Queue, ref FIGS. 4A-4C step 2a. The resultant line items are organized as shown in Table XXVIII. Each Item Queue has its allocation calculation on CLU Qty required.

TABLE XXVIII

| Queue 1 | | | Queue 2 | | |
|---|---|---|---|---|---|
| Item | DLU | DLU-Lot | Item | DLU | DLU-Lot |
| Item A | DLU1 | 300 | Item C | DLU2 | 200 |
| Item A | DLU1 | 150 | Item C | DLU2 | 100 |
| Item B | DLU1 | 430 | Item C | DLU2 | 25 |
| Item D | DLU3 | 750 | Item E | DLU2 | 15 |

Item A, Item B and Item D of Item Queue 1 all have identical allocation properties despite having different dispatch load unit DLU₁ and DLU₃. Item C and Item E have identical allocation properties since they have identical DLU₂. Item Queue 1 has an Allocable Quantity Q of 800 while Item Queue 2 has an Allocable Quantity Q of 500, both their Q value can be referenced from anyone of their line item Item Allocation Lookup Table.

Each Item Queue is to be sorted, ref. FIGS. 4A-4C step 2b, which can be in ascending or descending order based on preference. Here, we arbitrarily sort in descending order, ref Table XXIX.

TABLE XXIX

| Queue 1 | | | Queue 2 | | |
|---|---|---|---|---|---|
| Item | DLU | DLU-Lot | Item | DLU | DLU-Lot |
| Item D | DLU3 | 750 | Item C | DLU2 | 200 |
| Item A | DLU1 | 300 | Item C | DLU2 | 100 |
| Item A | DLU1 | 150 | Item C | DLU2 | 25 |
| Item B | DLU1 | 430 | Item E | DLU2 | 15 |

For Item Queue 1, line items Item A are grouped together with a super-DLU-Lot of 450, which is less than that of Item D of 750 and more than that of Item B of 430. Similarly for Item Queue 2, line items Item C with a total of 325 is more than that of Item E of 15.

Per FIGS. 4A-4C step 2c, each queue allocates to full CLUs. For Item Queue 1 with Allocable Quantity Q of 800, all of Item D and 50 of line 2 Item A are allocated to one full CLU, ref Table XXX. All of line 2 Item A remainder quantity of 250, rest of Item A and 400 of Item B are allocated to another full CLU. Remainder of Item B of 30 is left for follow on allocation. Total of two full CLUs results from Item Queue 1. As for Item Queue 2, the total DLU-Lot quantity of 340 is less than their Allocable Quantity Q of 500; thus no full CLU results and all are left for follow on allocation.

TABLE XXX

| Queue 1 | | | | Queue 2 | | | |
|---|---|---|---|---|---|---|---|
| Item | DLU | DLU-Lot | CLU | Item | DLU | DLU-Lot | CLU |
| Item | DLU3 | 750 | 1 | Item | DLU2 | 200 | |
| D | | | | C | | | |
| Item | DLU1 | 50 | | Item | DLU2 | 100 | |
| A | | | | C | | | |
| Item | DLU1 | 250 | 1 | Item | DLU2 | 25 | |
| A | | | | C | | | |
| Item | DLU1 | 150 | | Item | DLU2 | 15 | |
| A | | | | E | | | |
| Item | DLU1 | 400 | | Sub- | | | 0 |
| B | | | | Total; | | | |
| Item | DLU1 | 30 | | | | | |
| B | | | | | | | |
| Sub- | | | 2 | | | | |
| Total | | | | | | | |

### Allocation by Allocable Volume and Weight

Per FIGS. 4A-4C step 3, all the line items with their DLU-Lots are grouped into a single Item Queue. As with previous steps, all identical line items with identical dispatch load unit are grouped and sorted, as shown in Table XXXI.

TABLE XXXI

| Item | DLU | DLU-Lot |
|---|---|---|
| Item C | DLU2 | 200 |
| Item C | DLU2 | 100 |
| Item C | DLU2 | 25 |
| Item E | DLU2 | 15 |
| Item B | DLU1 | 30 |

All Item C are sorted, per FIGS. 4A-4C step 3a, and then all super-DLU-lots are sorted, per FIGS. 4A-4C step 3b. Sorting is by Allocable Volume V of DLU-Lot. Sorting maybe in ascending or descending volume. For illustration, descending volume is arbitrarily chosen. Despite Item B with larger quantity, its volume is assumed to be smaller than that of Item E, hence sorted after Item E.

Per FIGS. 4A-4C step 3c, allocation of item dispatch load units into CLUs follows the sorted sequence. Item dispatch load units are allocated to a CLU until the next item dispatch load unit exceeds the CLU interior volume.

If CLU maximum load limit is to be respected and if all the allocated item release units have a gross weight exceeding the maximum load limit of the CLU, then item dispatch load units are unallocated from the CLU in reversed allocation order until the CLU is not overloaded.

Allocation of item dispatch load units continues until all are allocated. The last CLU may result in not being fully utilized.

With reference to Table XXXII, it is assumed all the item dispatch load units can be allocated into one CLU.

TABLE XXXII

| Item | DLU | DLU-Lot | CLU |
|---|---|---|---|
| Item C | DLU2 | 200 | |
| Item C | DLU2 | 100 | |
| Item C | DLU2 | 25 | |
| Item E | DLU2 | 15 | |
| Item B | DLU1 | 30 | |
| Sub-Total; | | | 1 |

### Totaling Required Container Load Units

Per FIGS. 4A-4C step 4, all calculated CLU quantity from previous steps are summed for the total CLU quantity required to containerize all the items in the scenario. Based on the scenario, the total is as follows:
1. 18 CLUs from step #1 based allocation by Allocable Quantity on Items. 16 CLUs are from individual line items, indicated in Table XXV, and 2 are from Item Groups, indicated in Table XXVII.
2. 2 CLUs from step #2 based on allocation by Allocable Quantity on Identical

Allocation Properties, as indicated in Table XXX.
3. 1 CLU from step #3 based on allocation by Allocable Volume and Weight, as indicated in Table XXXII.
4. For the given scenario, the heterogeneous allocation algorithm derives a total of 21 (from 18 +2 +1) CLUs required.

### A More Complex List of Dispatch Load Units for Calculation

With the same logic but a more complex scenario, the list of items for containerization may be as set forth in the example of Table XXXIII.

TABLE XXXIII

| Dispatch | | | |
|---|---|---|---|
| Location | Item | DLU | DLU Qty |
| Location A | Item A | DLU1 | 3,350 |
| Location A | Item B | DLU1 | 430 |
| Location A | Item A | DLU1 | 1,100 |
| Location A | Item C | DLU2 | 5,600 |
| Location A | Item D | DLU3 | 750 |
| Location A | Item E | DLU2 | 15 |
| Location A | Item C | DLU2 | 25 |
| Location A | Item C | DLU2 | 350 |
| Location A | Item C | DLU2 | 450 |
| Location A | Item C | DLU2 | 400 |
| Location B | Item P | DLU1 | 350 |
| Location C | Item X | DLU99 | 350 |
| Location B | Item Q | DLU1 | 150 |
| Location B | Empty Box A | DLU9 | 200 |

Here, items are from three locations. Some items are from location A, some are from location B and some are from location C. Since each location must have their containers arranged for all the DLUs of that location, and may be specified with different CLU, DLUs are grouped and separated by locations. Heterogeneous allocation algorithm is applied to the line items of each location to determine the CLU quantity for each location. The total CLU quantity for the scenario is the sum of CLU quantity of each location.

### Packing Arrangement Details in Container Load Units

After a scenario has applied the Heterogeneous Allocation Algorithm and all the CLU allocations are determined, each container load unit can have their list of allocated item dispatch load units with quantity presented. However, for the details on each allocation block and the rows, columns and stacks in the block will depend on whether the container load unit is allocated by Allocable Quantity or by Allocable Volume.

All container load units that are allocated by Allocable Quantity in the heterogeneous allocation algorithm can have the dispatch load unit allocation arrangement details presented in blocks with rows, columns and stacks. This information can be referenced from anyone of the item dispatch load unit record allocated in the container load unit. This is applicable to any CLU determined from FIGS. 4A-4C step 1 and step 2.

Any container load units that are allocated by Allocable Volume in the heterogeneous allocation algorithm cannot have their dispatch load unit allocation arrangement details presented in blocks with rows, columns and stacks. How such a container load unit is packed is not being predetermined. This is applicable to any CLU determined from FIGS. 4A-4C step 3.

### Variations to the Heterogeneous Allocation Algorithm Model

Sorting DLU-Lot in FIGS. 4A-4C step 1 b, step 2b, step 3a and step 3b may be changed to another sorting method. There is no impact on calculating the CLU quantity required but may affect how a DLU-lot is split across CLUs when the remaining volume of the allocating CLU can only allocate partial quantity of the last allocating DLU-Lot.

The algorithm may support packing preference to not have any DLU-Lot to be split over different CLUs in FIGS. 4A-4C step 3. This has the benefit of reducing dispatch load unit fragmentation across CLUs but may increase the number of required CLUs for the scenario.

The algorithm at FIGS. 4A-4C step 3 may support sorting not by Allocable Volume but by other dispatch load unit properties. Since step 3 is an approximation system, it can be improved. However, the last CLU should always be allocated with lower utilization, as typically practiced, to accommodate for any reality variations so to avoid encountering the disruptive situation of insufficient CLU, which can be difficult to acquire at short notice.

While embodiments of the foregoing system have been set forth for purposes of illustration, the foregoing description should not be deemed a limitation of the invention herein. Accordingly, various modifications, adaptations and alternatives may occur to one skilled in the art without departing from the spirit and the scope of the present invention.

1. A system for determining container load units (CLUs) from dispatch load units (DLUs) comprising:
(a) providing a list of items with a quantity and weight associated with each said item;
(b) accessing a DLU database for multiple dispatch load units each comprising exterior height, exterior length, exterior width, gross weight, placement direction, maximum stacks and orientation data;
(c) identifying from said DLU database one or more suitable DLUs for each said item to define a group of IDLUs;
(d) calculating the quantity of IDLUs for each item;
(e) accessing a CLU database for multiple container load units each comprising interior length, interior width, interior height and maximum load data;
(f) calculating the quantity of CLUs from IDLUs based on the DLU and CLU databases; and
(g) allocating the IDLUs to each selected container load unit CLU to construct a table comprising items and quantities of IDLUs and CLUs.

2. The system of claim 1 further comprising accessing a preference database of packing preferences and employing a packing preference in one or more of steps (d), (f) and (g).

3. The system of claim 1 wherein for a given item, the IDLUs are homogeneous.

4. The system of claim 2 further comprising calculating the allocable quantity Q of each IDLU having a theoretical maximum allocable quantity possible for a CLU based on properties of the CLUs and the packing preferences and applying a preference to reduce the theoretical allocable quantity of the Q.

5. The system of claim 4 further comprising overriding of the dispatch load Q by a preferred empirical value.

6. The system of claim 4 further comprising recalculating the Q and for each IDLU comprising assigning an item weight and recalculating the Q based on a CLU maximum load property.

7. The system of claim 1 further comprising constructing a packing model of two possible packing arrangements for a front facing direction and a side facing direction.

8. The system of claim 7 wherein each said IDLU is a carton and each CLU is a container and further comprising for each container determining the upright lot, an adjacent lot and an overhead lot and calculating the allocable cartons as the sum of the cartons for each of the upright lot, the adjacent lot and the overhead lot.

9. The system of claim 8 further comprising overriding the allocable carton quantity by an empirical value.

10. The system of claim 1 further comprising for each IDLU performing a first round homogeneous allocation by determining a full container quantity for each IDLU and determining an unallocated remaining IDLU quantity for each IDLU.

11. The system of claim 10 wherein for all remaining IDLUs grouping each IDLU with identical packing properties into a super lot, and for each super lot, sorting the IDLUs and determining full container load unit quantity based on allocable item dispatch load quantity, and determining an unallocated remaining IDLU and quantity for each super lot.

12. The system of claim 11 wherein each container has a volume and further comprising sorting the item dispatch load unit by grouping all item dispatch load units with identical packing properties into a super lot, sorting the super lots to define a sort segment where a lot volume is based on a unit allocable volume V and wherein carton allocations of V is based on the sort sequence, and proceeding until allocation of the cartons is such that the total unit allocable volume of cartons does not exceed the container interior volume until all cartons are allocated, and summing the containers for the homogeneous allocation and the heterogeneous allocation.

13. A system for determining container load units (CLUs) from dispatch load units (DLUs) comprising:
(a) providing a list of items with a quantity associated with each said item;
(b) providing an DLU database for multiple DLUs each comprising exterior dimensional data;
(c) identifying from said DLU database a group of items specific DLUs (IDLUs) for each said item
(d) calculating the quantity of IDLUs for each item;
(e) providing a CLU database for multiple container load units each comprising interior dimensional data;
(f) calculating the quantity of CLUs from IDLUs based on the DLU and CLU databases; and
(g) allocating the IDLUs to selected CLUs to construct a table comprising items and corresponding IDLUs and CLUs

14. The system of claim 13 further comprising constructing a packing model for each of the selected CLUs.

15. The system of claim 13 further comprising providing a preference database and employing the preference database in one or more of steps (b), (d) and (f).

16. The system of claim 13 wherein said group of IDLUs comprises homogeneous and heterogeneous cartons and further comprising initially performing steps (d), (f) and (g) for homogeneous cartons and then performing the calculations of (d), (f) and (g) for heterogeneous cartons.

17. The system of claim 13 further comprising constructing a packing model of two possible packing arrangements for a front facing direction and a side facing direction, and then for each carton and a selected container, determining an upright lot, an adjacent lot and an overhead lot and calculating the allocable cartons as the sum of the cartons of each of the upright lot, the adjacent lot and the overhead lot.

18. The system of claim 13 wherein said DLU database comprises gross weight data and said CLU database comprises maximum load data and further comprising performing steps (d), (f) and (g) by employing said gross weight and maximum load data.

19. The system of claim 13 wherein said DLU database comprises placement direction, maximum stack and orientation data and further comprising employing the placement direction, maximum stack and orientation data to perform steps (d), (e) and (f).

20. The system of claim 1 further comprising constructing a lookup table comprising Allocable Quantity and unit Allocable Volume calculated for each IDLU and for each CLU for each item.
